(19) United States
(12) Patent Application Publication
(10) Pub. No.: US 2005/0171700 A1
(43) Pub. Date: Aug. 4, 2005

(54) Device and system for calculating 3D seismic classification features and process for geoprospecting material seams

(75) Inventor: William Kit Dean, Golden, CO (US)

Correspondence Address: BAKER BOTTS, LLP, 910 LOUISIANA, HOUSTON, TX, 77002-4995, US

(73) Assignee: Chroma Energy, Inc.

(21) Appl. No.: 10/769,681

(22) Filed: Jan. 30, 2004

(51) Int. Cl. G06F 19/00

(52) U.S. Cl. 702/16

(57) ABSTRACT

A device for calculating 3D seismic classification features constrained to be tangent to a path in a 3D volume is provided as a “geo-operator”. The method has the capability to associate horizontal (2D), vertical (2D) or arbitrary (3D) classification “feature vectors” with the geo-operator output, to allow determining where the geo-operator has sufficient data for the calculation to form a valid output and where the output of the geo-operator indicates a measure to which alternative feature vector prototypes may be present along the path. The geo-operator has the flexibility of using variable crossline, inline and vertical extent and having a direction able to be designated as it traverses the path, from the start point to the endpoint, aligned to be tangent to the path.

### CROSS REFERENCE TO RELATED APPLICATIONS

This application is related to commonly owned U.S. patent application serial number 6466923B1, filed Apr. 29, 1998, issued Oct. 15, 2002, entitled “METHOD AND APPARATUS FOR BIOMATHEMATICAL PATTERN RECOGNITION,” by Fredic Young; to U.S. patent application Ser. No. 10/308,933, filed Dec. 3, 2002, entitled “PATTERN RECOGNITION APPLIED TO OIL EXPLORATION AND PRODUCTION” by Robert Wentland, et al.; to U.S. patent application Ser. No. 10/308,928, filed Dec. 3, 2002, entitled, “METHOD, SYSTEM, AND APPARATUS FOR COLOR REPRESENTATION OF SEISMIC DATA AND ASSOClATED MEASUREMENTS,” by Robert Wentland, et al; to U.S. patent application Ser. No. 10/308,860, filed Dec. 3, 2002, entitled “PATTERN RECOGNITION TEMPLATE CONSTRUCTION APPLIED TO OIL EXPLORATION AND PRODUCTION,” by Robert Wentland, et al.; to U.S. patent application Ser. No. 10/308,880, filed Dec. 3, 2002, entitled, “PATTERN RECOGNITION TEMPLATE APPLICATION APPLIED TO OIL EXPLORATION AND PRODUCTION,” by Robert Wentland, et al.; the latter four patent applications all being conversions of U.S. Provisional patent application Ser. No. 60/395,960, filed Jul. 12, 2002; all five co-pending Non-provisional patent applications being hereby incorporated by reference herein for all purposes.

### FIELD OF THE INVENTION

This present invention relates generally to the field of geoscience exploration of natural resources and more specifically to a process and system for visualizing pattern recognition by calculating 3D-classification features based on seismic and non-seismic data for exploration of material seams.

### BACKGROUND OF THE RELATED ART

A commonly used diagnostic for studying the subsurface of the earth under large geographical areas relies on seismic signals (acoustic waves) that are introduced into the subsurface and reflected back to measurement stations on or near the surface of the earth. Current practice in exploration of natural resources relies on the use of interpretable 3D surveys, using either land or sea based acoustic sources and receivers. In three-dimensional seismic exploration, the point sets of seismic survey data are used to determine the subsurface reflecting interfaces. When properly processed, the cross patterns of energy emanating from the multiple sources and scattered into receivers can be later interpreted to indicate the strike, dip and velocity characteristic of the underlying reflection surfaces. Such acquisition processing allows the use of computer techniques to provide a clearly resolved, three-dimensional display of a volume of the subsurface earth. The four-dimensional vector data (vector values at voxel indexed by the 3D coordinates corresponding to inline, crossline and depth indices) can be considered an array of voxel matrix values representing the reflection surfaces. Visualization techniques used to render such a display for a geoscientist interpreter are well known to those skilled in the art. Heretofore, a common technique is to simply display the seismic or seismic derived amplitude at its corresponding inline, crossline and depth voxel cell position with a color or false-color attribute (along with any other, non-seismic data needed or available). This allows a skilled interpreter to visualize the strike and dip of reflections that denote stratigraphic and structural surfaces. The use of feedback control of excavation for resources is also well understood by those skilled in the art, in which feedback control using sensor data is used to control the operation of excavation or boring tools. In general, the purpose of such control is to prevent the drilling tool from migrating into non-pay regions and lowering the productivity of the recovery of the natural resource. In some variations of the feedback control of excavation, energy sources other than seismic are used for the information, and the radiator of the energy may be on the drilling tool.

The natural resources we seek to find and evaluate are contained in three-dimensional traps or seams. Collection of closely spaced seismic data over a geographic area permits three-dimensional evaluation of the data as a volume. The interpretation customarily performed by geoscientists separates pay or producing regions from non-pay or dross regions, using seismic and or non-seismic data. The subsurface seismic wave field is closely sampled in the inline, crossline and depth directions, and potentially the interpretation can use the totality of all the stored, finely-sampled information. The skill of the interpreter in filtering the three-dimensional relationships of the stratigraphic and structural characteristics of the data effectively reduces the decisions to evaluation of a relatively few eigenvectors in the decision space. Thus it can be seen that the complex skills and reasoning of the interpreter take the dense, finely sampled data of the processed seismic wave field and reduce the number of required descriptors or features needed to make a decision. The interpretation result may be viewed as a map by which the interpreter has used a complex, possibly nonlinear relationship of the features to indicate boundaries, in a multidimensional decision space which can be referred back to the physical space to separate regions based on utility. It will be understood by those skilled in the art, that each interpreter may wish to use a different map based on his own prejudices or weighting and use of linear or nonlinear transformations, and a method to accomplish this tailoring should be provided.

Conventional seismic data analysis uses flattening merely by adjusting voxel heights to flatten along a picked horizon, and then proceeds by making calculation on the flattened plane. Unfortunately, these conventional flattening techniques of present seismic data analysis are limited because the flattening destroys some of the geometric information associated with the depositional play of deposits. This corruption of the data by the flattening obscures the interpretation of changes in the calculation of physical quantities because it contaminates the observation of physical changes with changes due to projections of geometry.

In conventional analysis of seismic 2D or 3D data, a horizon is flattened purely for ease of calculation, to allow calculation to proceed in a Cartesian analysis space. This ordinary flattening causes a loss of information since changes along dip and strike are ignored and a Cartesian calculation is performed along vertical planes without regard to the actual physical deposition as it exists in 3D space. Thus, calculations which are made along the Cartesian (X, Y, and Z) directions along a flattened seismic volume are often inferred to describe the actual nearby physical deposits in some gross, but incorrect, statistical sense. When using a calculation this way on flattened data, the information is thus effectively artificially compressed onto a plane (usually horizontal) by ignoring the vertical and horizontal offsets of the true dip and strike. It can be seen that the local error in following the Cartesian planes instead of the true dip and strike is merely absorbed into, and corrupting, the statistics of the calculation. Some of the information of value in a geologic setting derives from the change in a physical observable, such as the wetting angle of a hydrocarbon-water interface in a trap. This type of depositionally oriented information is distorted by ignoring the dip and strike orientation when the calculation is simply collapsed onto a nearby plane if ordinary flattening is used. It can be seen that by this erroneous use of a Cartesian analysis space causes out-of-plane errors (in 3D) to be added to the inferred projection of the data on a plane (2D), thus obscuring the interpretation of the actual physical changes that exist along dip and strike. These errors are path-dependent, which requires a great deal of interpretation time to extract the true physical picture of the depositional structure. In the case where an entire sheet horizon is selected on which to perform calculations, inherent errors can be seen to result since a trap generally does not extend over an entire sheet horizon, and the intersection of the trap geometry with such a sheet horizon only occurs over a small area or volume, which inherently means that calculations made on such a sheet horizon may not detect the hydrocarbon or pay zone.

The existing art indicates that the many techniques that have been previously applied to geoscience do not address the explicit problems listed above. For the most part the prior art does not focus on providing solutions of the same pattern recognition genre needed for a solution since prior art has not explicitly addressed the specificity of the problems listed above. None solve the problems, as can be seen by examining the prior art described below.

Most seismic data calculations have been performed to form a result over a horizon or a volume. The approaches that are nearest to that of the present paper are those that conduct such calculations in a difference mode in order to locate discontinuities in the seismic volume. This is done while calculating variances or to locate faults. Cheng et al (U.S. Pat. No. 6,490,528 for “Method for Imaging Discontinuities in Seismic Data”) describes a different but analogous method of detecting changes in an overall volume of seismic data by identifying changes between pairs of traces. Their method compares pairs of seismic data traces by taking a number of thresholds to determine where directional changes occur in order to find discontinuities. Matteucci, (U.S. Pat. No. 5,884,229 for “Method for Measuring Lateral Continuity at a Specified Subsurface Location from Seismic Data”), does provide a method of employing calculations of seismic data along a path, but solely for measuring lateral continuity between laterally or vertically adjacent traces. Matteucci considers a variety of statistics to compare the traces. His method can be used in a reconnaissance mode to discover spatial geometric features in the data that are suggestive of certain geologic and/or depositional environments, and the top and bottom horizons would be either regular time horizons or slanted time horizons.

The method of Van Riel and Tijink (U.S. Pat. No. 6,401,042 for “Method of Determining Spatial Changes in Subsurface Structure, Stratigraphy, Lithology, and Fluid Content and of Reducing Noise”) is to calculate the rate of change of seismic variables over “every grid point” of subsurface stratigraphic horizons. A segment of the local surface patch of the horizon is studied by analyzing the data from a group of gridpoints centered about the point of interest and performing a rotation in pitch and yaw (inline and crossline) in order to record the rate of change and direction of change of the data. In this way the dip and azimuth of the tangent plane to the local stratigraphy is found. Riel and Tijink claim the method of determining the data at the (inline and crossline) grid points of the surface patch being calculated by interpolating or averaging over neighboring grid points. Riel and Tijink claim the method of vertical averaging to include the method of averaging over a vertical interval equal to the (micro) horizon interval spacing and centered at the current horizon.

The tracking of the calculation along a path of a geological strata is analogous to tracking of a surface. It can be appreciated that tracking of contours is useful in the manufacturing arts such as in U.S. Pat. No. 4,368,462 (for “Apparatus for Automatic Tracking and Contour Measurement”) where the surfaces of a physical object are automatically tracked and detected to provide computer-numerically control of a cutting machine to produce a copy of the object. Similarly the confinement of the calculation to useful areas finds an analogy in the detection of cutting errors when mining for ore is used to reduce product contamination by prevent the cutting from migrating into a vein of nonproductive material. This is customarily done by sampling the cut product (such as in U.S. Pat. No. 6,435,619 and U.S. Pat. No. 5,092,657) or by ensuring that the cut material has the proper physical properties (such as in U.S. Pat. Nos. 5,310,248 and 5,158,341).

As taught for use in document recognition by Crawley, in U.S. Pat. No. 4,368,462 for “Line Follower”. “Line following may be generally defined as a process where a line . . . is given a mathematical definition in terms of X and Y coordinates. These coordinates generally consist of a start point and a series of further points depicting the meandering direction of a line and with the coordinates then further defining an end point.” Crawley's disclosure pixelates a document by line scanning to represent the picture of the document by its underlying line contours. Crawley describes a technique where
“ . . . several accompanying attributes are assigned to the series of coordinates defining each line so as to fully complete the digital representation of the line on the document. In particular, analog features such as line thickness, color and feature representations are some of the attributes that may be used to finalize the picture content of the document.”

A different but distantly related technique of region-based calculation may be seen in the concept described by Howard for a tile-by-tile auto picker, which starts at a seed point and grows the region of tiles by accepting adjacent tiles which satisfy the criterion of a calculation result, (U.S. Pat. No. 5,056,066 for “Method for Attribute Tracking in Seismic Data”).

Grismore et al, in U.S. Pat. No. 6,574,566 “Automated Feature Identification in Data Displays,” teaches a method of accumulating and displaying features of instantaneous time attribute data in a scale-independent way, based on tomographic-encoded paths defined within a sub-volume having the shape of a sphere or other bounding surface. In this way, aggregate (vector) attribute values at a point within the bounding object can be mapped in a direction along a tomographic path from the center of the bounded volume to the surface. By using this encoding and display method, similar sub-volume displays can be compared based on their tomographic attribute maps, and identification of geologic and stratigraphic features can proceed in a non-subjective way. For instance, for seismic data, feature identification is assigned to the sub-volume (from methods such as correlation of the data with customary prototypical geologic and stratigraphic features such as onlap, downlap, unconformity or faults rollover, saddle), and a data volume is displayed with the values coded for those prototypical features that are identified to be present by calibration.

The specific calculation of the raw variance of a seismic in a seismic volume having equal inline and crossline extents (a variance cube) is covered in U.S. Pat. No. 6,151,555 for “Seismic Signal Processing Method and Apparatus for Generating a Cube of Variance Values”.

Keller and Krammer (U.S. Pat. No. 6,141,622 for “Seismic Semblance/Discontinuity Method”) provide a method to extract a calculated attribute from 3D traces within a spatial and time window. Successive calculations can be made using overlapping windows. The calculation is dependent, at least in part, on the ratio of the square of the sum of the amplitudes of the traces and the sum of the squared amplitude of the traces. The inline and crossline extent of the calculation could be made independent, and the calculation could be made in two, substantially orthogonal, planes. The vertical extent of the calculation was not an element of Kelly's disclosure. Overall, the calculation has the flavor seen previously in the prior art as a bulk process using the data from the whole seismic volume or sub-volume under study.

Alam (U.S. Pat. No. 6,278,949 for “Methodfor Multi-Attribute Identification of Structure and Stratigraphy in a Volume of Seismic Data”) teaches a method of automated segmentation for providing a model of subsurface earth layers. A seismic volume is modeled as a collection of events locations where a specified phase occurs along the vertical traces. Temporal attributes are calculated at each event location to characterize the waveform in a short (vertical) time window. A smooth approximating surface, the local wavefront, is estimated such that it passes exactly through the time at an event and best fits the times of most similar events on laterally separated traces (in the inline and crossline directions). A ‘local attribute surface’ is estimated for each signal attribute in a manner similar to the estimation of local wavefront. The set of attributes formed by the union of temporal and spatial attributes is represented as a vector whose k-th component is denoted as Ak (x, y, i, j). Thus the procedure maps an event in 3D space (x, y, t) into an N-dimensional calculated signal attribute space. Any subset of individually normalized attributes is then selected and combined on a graphical workstation into an indicator functional, with its range of values mapped in a color spectrum. These attributes are fundamentally signal attributes, rather than “recognizers of patterns” to be used as classification tools.

The method of 3D display of survey information is well known in the prior art (U.S. Pat. Nos. 4,558,438 and 4,633,448 are representative).

Ahern, et al. (U.S. Pat. No. 4,759,636 for “Method and System for Real-time Processing of Seismic Data”) devised a system to quickly and accurately determine if the acquisition parameters established for a multi-channel seismic system are producing interpretable results by checking in real-time the moveout correction for stacking of seismic traces.

Verly, et al. in U.S. Pat. No. 5,123,057 for “Model Based Pattern Recognition” provides a target recognition-matching machine using models. The matching machine uses recursive procedures to match data event portions against predefined hierarchical models of desired physical entities.

Bishop in U.S. Pat. No. 5,848,379 for “Method for Characterizing Subsruface Petrophysical Properties Using Linear Shape Attributes” discloses the use of reference traces and concatenates adjacent traces to form a “linear shape attribute”, but the analysis technique is limited by the requirement on the features formed to have this adjacent contiguity. A singular value decomposition technique is used which depends on the data traces having equal length, which is a limitation of the technique.

Schneider et al (U.S. Pat. No. 6,016,462 for “Analysis of Statistical Attributes for Parameter Extraction”) presents a method of iterative processing of data based on performance in calculating a seismic attribute of the data, including sweeping the parameters of the calculation to optimize the postprocessing of acquired data.

Scott, in U.S. Pat. No. 6,049,760 for “Method of and Apparatus for Controlling the Quality of Processed Seismic Data,” provides a technique for controlling the quality of processed seismic data without requiring subjective intervention. Scott's technique measures the quality of post processing of data based on using alternative parameters in the various stages of seismic processing such as gather velocity analysis, deconvolution, stack migration and filtering. Signal attributes are studied after an initial preliminary processing to determine how to best finish the processing of the batch of seismic data.

U.S. Pat. No. 5,585,556 for “Method and apparatus for Performing Measurements While Drilling for Oil and Gas” relates to a method and apparatus for performing measurements while drilling for oil and gas, with sources mounted on the surface and the geophones on the surface and in the drill string. The vertical seismic measurements thus obtained are useful in an active manner as a direction control device during drilling operations.

Wisler in U.S. Pat. No. 5,812,068 for “Drilling System with Downhole Apparatus for Determining Parameters of Interest and for Adjusting Drilling Direction in Response Thereto” relates to excavation of natural resources. Downhole sensors measure relatively large amounts of raw data, and these data are processed to be reduced to parameters of interest that may be utilized to control the drilling operation.

Tanner in U.S. Pat. No. 6,487,502 “System for Estimating the Locations of Shaley Subsurface Formations” provides a method to use the Hilbert signal attributes of the seismic data that attempt to calibrate to physical effects in underground strata without making use of pattern recognition classification techniques.

U.S. Pat. No. 6,490,526 for “Method for Characterization of Muliti-Scale Geometrical Attributes” provides a method of iteractively scaling analysis windows in order to optimize the calculation of signal attributes of seismic data in order to correctly resolve a geometrical structure.

Malinvemo (U.S. Pat. No. 6,549,854 for “Uncertainty Constrained Subsurface Modeling”) uses iterative statistics in creating a model of a subsurface area. The updating technique is used to refine and improve the probabilities of correct modeling.

Meek (U.S. Pat. No. 6,597,994 for “Seismic Processing System and Method to Determine the Edges of Seismic Events”) provides a bulk method of calculating coherence statistics using the Hilbert signal attributes for a seismic volume by using matrix mathematics on the dataset.

Dablain (U.S. Pat. No. 6,587,791 for “System and Method for Assigning Exploration Risk to Seismic Attributes”) provides a weighting technique to assess geologic factors affecting hydocarbon presence. The presence of signal attributes is ascribed to various confidence factors to build up the likelihood for the presence of required geologic structures.

Bush (U.S. Pat. No. 6,411,903 for “System and Method for Delineating Spatially Dependent Objects, Such as Hydrocarbon Accumulations From Seismic Data” teaches a technique of using neural net kriging to delineate structures in data as a prealerted detection of an edge, forming a method to detect gradients in data. The technique uses a training set based on part of the data to form a type of sameness detector in order to delineate observed edges. In actuality, this neural net technique detects the variance in classification, and is hampered by being restricted to comparing adjacent lines. A further limitation is that a fixed classification criterion is used with variable weighting, thus causing the classification edge to be purely a local boundary. (The variance of the training set is not separately monitored during the classification process.)

West and May (U.S. Pat. No. 6,438,493 for “Methodfor Seismic Facies interpretation Using Textural Analysis and Neural Networks”) and U.S. Pat. No. 6,560,540 for “Method for Mapping Seismic Attributes Using Neural Networks” both teach a method of using neural nets to identify facies in a seismic volume. A number of 2D areas on a 2D slice are selected as a representation of the desired image. The contiguity statistics of the 2D pixels of the each of the areas is calculated. These statistical results provides a means of teaching a neural net to be able to detect which other parts of the dataset might be probabilistically similar. These methods are hampered by the fact that the selected number of 2D areas must a priori represent a subset of the underlying classifications, which effectively converts the neural net technique to merely yield a rough detector of similarity of likelihood.

These methods in the prior art suffer from the deficiencies that the calculations themselves do not tailor to the dip and strike of local stratigraphy, often do not lend themselves to employ non-Cartesian coordinates, and in some instances cause the statistics calculated from bulk seismic data to render less effective evaluations. Techniques in the literature which employ classification features do not provide a means to deal with the need to flatten the data and must either pre-flatten the data or cause the use of calculations that suffer from the inability to follow local stratigraphy. Techniques that provide a calculational tool for the finding a measurement attribute of seismic usually use a bulk method of calculation over the entire seismic volume, and only then subsequently may calculate a gradient. Some of the methods in the prior art do monitor changes in calculated results, but are implemented to require a Cartesian system of coordinates to sweep out the data volume. What is needed instead is an operator technique that allows the validity of statistics about a point to be enhanced by restricting the operator extent and calculation direction to point along the underlying geologic patterns. Such a technique for the calculation to have a real-time significance in showing the gradient of statistical change as a geologic structure is traversed using a tensor output and input, and capable of non-Cartesian orientation has heretofore been absent. Having such a technique, a geoscientist could track geology with the calculation, thus greatly assisting in more meaningful evaluation of economic potential of the prospecting leads.

Thus it can be seen that a need exists for a device that can calculate a quantitative output indication of the condition of 3D-classification features in geoscience data, provides for the effective flattening of seismic-type data in a very computationally economic method, has the ability to provide tensor outputs, and can be used to provide a unique method of quantitatively combining seismic and non-seismic data to condition classification decision boundaries and thus accomplish data fusion. This need is fulfilled by the present invention which is useful for the novel and nonobivious solution of these problems and which has heretofore not been available as is described in the remainder of this disclosure.

### SUMMARY OF THE INVENTION

The present invention solves many shortcomings of the prior art by producing a method of applying a calculation of seismic data along the path of a vein of geologically significant material in such a way that the geological information associated with the depositional play is preserved, thus obviating the need to flatten the data. In conventional analysis of seismic 2D or 3D data, a horizon is flattened purely for ease of calculation, to allow calculation to proceed in a Cartesian analysis space. This ordinary flattening causes a loss of information since changes along dip and strike are ignored and a Cartesian calculation is performed along vertical planes without regard to the actual physical deposition as it exists in 3D space. Thus calculations which are made along the Cartesian (X, Y, and Z) directions along a flattened seismic volume are often inferred to describe the actual nearby physical deposits in some gross, but incorrect, statistical sense. When using a calculation this way on flattened data, the information is thus effectively artificially compressed onto a plane (usually horizontal) by ignoring the vertical and horizontal offsets of the true dip and strike. It can be seen that the local error in following the Cartesian planes instead of the true dip and strike is merely absorbed into, and corrupting, the statistics of the calculation. Some of the information of value in a geologic setting derives from the change in a physical observable, such as the wetting angle of a hydrocarbon-water interface in a trap. This type of depositionally oriented information is distorted by ignoring the dip and strike orientation when the calculation is simply collapsed onto a nearby plane if ordinary flattening is used. It can be seen that by this erroneous use of a Cartesian analysis space causes out-of-plane errors (in 3D) to be added to the inferred projection of the data on a plane (2D), thus obscuring the interpretation of the actual physical changes that exist along dip and strike. These errors are path-dependent, which requires a great deal of interpretation time to extract the true physical picture of the depositional structure. In the case where an entire sheet horizon is selected on which to perform calculations, inherent errors can be seen to result since a trap generally does not extend over an entire sheet horizon, and the intersection of the trap geometry with such a sheet horizon only occurs over a small area or volume, which inherently means that calculations made on such a sheet horizon may not detect the hydrocarbon or pay zone.

In contrast, the present invention provides a novel method to detect the presence of change of geologic data which allows the geometric information associated with the depositional play to be preserved by causing the calculation to follow along the actual 3D horizon during the calculation. This has the advantage that the statistics of changes along the geodesic path can be calculated in-situ to a geodesic line or surface, which conforms to a physical structure, and the statistics can be used to differentiate the structure from nearby structures. Changes in the statistics due to the deformation of the deposition onto a plane, which are customary when the inferior method of ordinary flattening, are eliminated. This results in a clearer picture that the changes in the statistics along the depositional vein represent changes in physical quantities, rather than being caused by an artifact of projection or collapse of the data during artificial compression onto a nearby plane. The area or volume that the calculation engages at each point along the path can be selected to exclude adjacent areas or volumes that are not of geologic consequence, thus improving the validity of the inferences made by excluding extraneous data in the calculation. The calculation can be tailored to occupy a physical structure such as a trap, and the tailoring can be performed to limit the calculation to comprise only the fluid-bearing portion of the structure, thus greatly aiding the hydrocarbon-finding utility of the calculation. Thus by allowing the calculation path to coincide with the trap geometry, a topological horizon can be used which improves the validity of the resulting calculation in determining significant changes. Such calculations can be used in a feedback mode to detect where discontinuities in the calculation arise not from a change in a geologic deposition, but instead can only be attributed to signal acquisition errors or from an abrupt mathematical discontinuity such as would result from a fault.

The calculation proceeds along a chosen path, typically that for a trap geometry. Because the change along the path must be able to be attributed to physical changes rather than mathematical artifacts, the coordinate system must travel with the operator in 3D. This means that the orientation of the operator must align with the path. Since voxel space is discrete, interpolations of the values of the operator between voxel points is required during rotations to align to the path so as to not introduce errors. A sufficient number of extra voxels need to be carried along with the operator size to allow rotations to proceed with enough voxels to allow the correct interpolation. The zone of valid calculations is circumscribed by the portion of the path for which a sufficient number of voxels is available for the given geo-operator size, in 3D. The methods used to perform the calculation on the path are independent of the method of designating the path, and the points of the path can be selected by any variety of methods used to designate a geodesic line. Because the physical changes exist along the geodesic line are inferred to result from geologic changes, the boundaries for pattern recognition are found along the lineal path of the geodesic line. The task of sorting areas or boundaries in the pattern space that otherwise occurs when the statistics of an ordinary Cartesian volume are calculated is greatly eased since the statistics are confined to lay along the geodesic line. Thus the patterns that are discovered from statistics are closely related to the underlying geologic patterns, and this relation is so close that one can be substituted for the other. This allows visual pattern recognition to proceed from the calculation of geologic change along the geodesic path that represents the trap geometry.

The present invention supplants the statistic method in evaluating geobodies and the need to develop a local coordinate neighborhood by the novel consideration of direction of calculation. This fundamental change allows the statistic method of analysis to overcome the difficulties associated with using unflattened data, avoiding the need to form segmentation over large areas in lateral directions, while preserving the underlying information in the patterns without the need to use a deformation.

The principal objects of the invention may be grouped (without implying that any of these are subordinated):

1. The primary object of the invention is to provide a means for implementing direct hydrocarbon indication (DHI) based on 3D features of seismic and other sensor data. Another object of the invention is to provide a means to allow 3D features to be generated and interpretable in terms of groupable horizontal and vertical 2D features. Another object of the invention is to provide tensor measure of quantities to allow 3D features to be created and measured.

2. It is an object of this invention to provide a method to obviate the need for flattening by provide a alternative to attempting to correct for distortion flattening. Yet another object of the invention is to allow the use of 3D operators on unflattened data thus eliminating the need for flattening of the data. Another object of the invention is to eliminate errors associated with use of ordinary Cartesian operators when applied to unflattened data, and which would otherwise require flattening. Still yet another object of the invention is to convert a body of seismic data to an “operator-flattened” form, by the successive use of the operator, which can then serve to catalog the transformation from the original dataset to a manifold aligned to the strata.

3. A further object of the invention is to use empirical computational statistics for the intent of evaluating the change of features on a path thereby enhancing the utility of the statistics, rather than simply using the statistics as an ordinary filter of the seismic data to measure the general presence of the feature in a volume. Thus, it is an object of this invention to provide a method by which the statistics of calculation are confined to physical, geodesic paths thereby rendering them to be a measure of the contents of the physical trap structure. It is an object of this invention to provide a method to reduce the computation workload of geo-statistics calculation by confinement of the calculation to be performed only to the physically significant locations. It is an object of this invention to provide a method that scales the statistics of calculation along a geodesic path by the neighborhood of the location of the geo-operator, and by observing the change in statistics with change in geo-operator neighborhood to infer a change in the geologic variables along the geodesic path.

4. It is an object of this invention to provide a vehicle to allow computations to proceed along geologic structure which are independent of the geo-operator calculation kernel, or which allows a modularized geo-operator calculation kernel to be used or substituted. Another object of the invention is to confine the calculation to a path of interest, (typically representative of a major axis of a geobody). Another object of the invention is to be able to tune the size of the geo-operator to the cross-sectional size of the geobody at that point along the path.

5. It is an object of this invention to provide a method by which the pattern recognition can be accomplished concurrently with visualization rendering by making calculations that follow geologic or topologic structure or follow geodesic paths. It is an object of this invention to provide a method by which the statistical calculation along a geodesic path intrinsically allows a pattern to be recognizable in 3D, which eliminates the dependence on separating classes using only statistical boundaries as is done in ordinary pattern recognition. Still yet another object of the invention is to allow interpreters to tune such geo-operators to best enhance the pattern recognition, thus allowing them to tune classification boundaries empirically. Another object of the invention is to enable statistics measures to reflect classification boundaries and to restrict classification boundaries to physical boundaries.

6. Yet another object of the invention is to provide a reconnaissance mode to mine for potentially valuable geologic bodies. It is a further object of this invention to provide a method to self-correct horizons on the basis of calculation, by use of the geo-operator technique in such a reconnaissance mode. Yet a further object of the invention is to provide a post-classification method to mine the original seismic data as a closed form expression

In accordance with a preferred embodiment of the invention, there is disclosed a device for calculating and displaying 3D seismic classification features comprising: a means of designating a path in a 3D volume, a geo-operator calculated from the voxel data of said 3D volume, said geo-operator capable of having variable crossline, inline and vertical extent and having a direction able to be designated such that it can be maintained tangent to said path, as it traverses from the start point to the endpoint of said path, a means of associating horizontal (1D), vertical (1D) feature vectors into 2D feature vectors and to use such 2D as well as arbitrary (3D) feature vectors in forming the geo-operator output, a means of determining where the geo-operator has sufficient data for the calculation to form a valid output, where the output of the geo-operator indicates a measure to which such alternative prototypical feature tensors may be present along the path.

In accordance with a preferred embodiment of the invention, there is disclosed a process for a device for calculating and displaying 3D seismic classification features relying on a means of designating a path in a 3D volume, employing a geo-operator calculated from the voxel data of said 3D volume, said geo-operator capable of having variable crossline, inline and vertical extent and having an orientation direction such that it can be maintained tangent to said path, as it traverses from the start point to the endpoint of said path, using a means of associating horizontal (1D), vertical (1D) and arbitrary (3D) feature vectors with the geo-operator output, with a means of determining where the geo-operator has sufficient data for the calculation to form a valid output, and where the output of the geo-operator indicates a measure to which alternative prototypical feature tensors may be present along the path.

In accordance with an alternative embodiment of the invention, there is disclosed a process for a device for employing 1D, 2D and 3D seismic classification features relying on a means of designating a path in a 3D volume, employing a geo-operator calculated from the voxel data of said 3D volume, said geo-operator capable of having variable crossline, inline and vertical extent and having an orientation direction such that it can be maintained tangent to said path as it traverses from the start point to the endpoint of said path and employing feature correlation to identify the translation and scaling of the geo-operator in order to provide a cardinality transformation of the underlying strata to form a manifold.

The present invention can use an apparatus for calculating and displaying 3D seismic classification features. Specifically, the apparatus includes a designation means for designating a path in a 3D volume, a reference means for selecting a reference starting and ending position, a geo-operator calculated from the voxel data of the 3D volume, the geo-operator capable of having variable crossline, inline and vertical extent. The geo-operator typically includes an orientation direction such that it can be maintained tangent to the path, as it traverses from the start point to the endpoint of the path, an association means for associating horizontal (2D), vertical (2D) and arbitrary (3D) feature vectors with the geo-operator output, and a determination means for determining where the geo-operator has sufficient data for the calculation to form a valid output. The purpose of the apparatus is to have the output of the geo-operator indicate a measure to which alternative prototypical feature tensors may be present along the path.

The present invention also includes a process for a device for calculating and displaying 3D seismic classification features relying on a means of designating a path in a 3D volume. The process includes employing a geo-operator calculated from the voxel data of the 3D volume, the geo-operator capable of having variable crossline, inline and vertical extent and having a an orientation direction such that it can be maintained tangent to the path, as it traverses from the start point to the endpoint of the path, using an association means of associating horizontal (2D), vertical (2D) and arbitrary (3D) feature vectors with the output of the geo-operator, and using a determination means for determining where the geo-operator has sufficient data for the calculation to form a valid output. Again, the purpose of the method is for the output of the geo-operator to indicate a measure to which alternative prototypical feature tensors may be present along the path.

Alternative embodiments of the present invention include an apparatus for calculating and displaying 3D seismic classification features. The apparatus has a path in a 3D volume, the path having a reference start position and a reference end position, and a geo-operator capable of generating an output, the geo-operator. The geo-operator includes an evaluation component that determines where the geo-operator has sufficient data to generate the output. The purpose of the apparatus is for the output of the geo-operator to indicate a measure to which alternative prototypical feature tensors may be present along the path. The feature vectors can be horizontal, vertical, and or arbitrary. Moreover, the feature vectors can be two-dimensional and/or three-dimensional. Typically, the geo-operator is calculated from voxel data of the 3D volume. The geo-operator can have a variable crossline and/or variable inline. The geo-operator can also have a vertical extent. In alternate embodiments, the geo-operator can have an orientation direction that is constructed and arranged to be maintained tangent to the path from the start position to the end position. Generally, one or more of the feature vectors are associated with the output of the geo-operator.

Another embodiment of the present invention is a method for calculating and displaying 3D seismic classification features along a path having a startpoint and an endpoint. This embodiment employs a geo-operator that is calculated from voxel data of the 3D volume, the geo-operator is capable of having variable crossline, inline and vertical extent and having an orientation direction that is maintained tangent to the path as the path is traversed from the startpoint to the endpoint, the geo-operator generating output along the path. Moreover, this embodiment determines where the geo-operator has sufficient data to generate the output, generates output with the geo-operator, and associates horizontal, vertical and arbitrary feature vectors with the output of the geo-operator. The purpose of this alternate method is for the output of the geo-operator to indicate a measure to which alternative prototypical feature tensors may be present along the path.

Another embodiment of the present invention is an apparatus for locating an underground structure. This apparatus includes a source of sensor information, 3D data covering at least a portion of the structure, and a geo-operator on a path within the 3D data. The geo-operator is constructed and arranged to conform to the direction and the orientation of a tangent to the path. Moreover, the geo-operator is also constructed and arranged to alter its size dynamically depending on the conditions of a point along the path. In addition, the geo-operator may be further constructed and arranged to correlate with physical phenomena in order to describe a natural resource. The geo-operator can also be constructed and arranged to correlate with physical phenomena in order to align with a boundary for a natural resource, and/or provide a mathematically discernible boundary for a natural resource. The sensor provides information about electromagnetic (including electric and magnetic) characteristics, gravity and/or particulate. The sensor information can be seismic as well, or the seismic information can consist of electromagnetic, gravity, and/or particulate information. Finally, a well can be drilled so that some portion of the natural resource can be recovered.

An alternate embodiment of the present invention is a method of generating a map that displays a set of geologic characteristics that are specific to a path. The path is composed of a plurality of points. The method includes assigning a calculation result based on the combined horizontal and vertical features centered at each point along the path, assigning a visual indication of the result to each point of the path, and assigning a validity measure to each of the points based on the availability of data in order to makes one or more changes in the result that are discernible by an interpreter.

Another embodiment of the present invention is a method of developing a cardinality transformation that includes designating a path in a 3D volume, determining, with a fitness function, the status of a selected reference classification feature in a form at an adjacent path position, determining the translation movement of the position of a centroid of the classification feature in the transition to the adjacent path position, determining the morphing scaling of one or more extents of the feature in the transition to the adjacent path position, and recording the translation movement and the morphing scalings to form a catalog of the changes in the strata manifold. The selected reference classification feature can be one dimensional, two dimensional, or three dimensional. The status can be present or absent. The form can be morphed or unmorphed. The method can also include a step of selecting a starting position and an ending position along the path.

Another embodiment of the present invention is a method of data fusion that includes providing a path having a plurality of points, performing a first calculation with a geo-operator using a first type of data in a calculation algorithm, performing a second calculation using a second type of data to form an output of the geo-operator, and switching the order of the first calculation and the second calculation at each point along the path. The output of the geo-operator provides an indication of both sensor data for determining the classification nature of each point on the path.

An alternate embodiment is a method of data fusion that includes providing a path having a plurality of points; performing a first calculation with a geo-operator using a first type of data in a calculation algorithm, performing a second calculation using a second type of data to form an output of the geo-operator, and admixing the first calculation and the second calculation at each point along the path. The output of the geo-operator provides an indication of both sensor data for determining the classification nature of each point on the path. The admixing can be linear or nonlinear. The admixing may also be mathematical.

Another embodiment is a method of data fusion that provides a path having a plurality of points, performs a first calculation with a geo-operator using a first type of data in a calculation algorithm, performs a second calculation using a second type of data to form an output of the geo-operator, and blends the first calculation and the second calculation at each point along the path. The output of the geo-operator provides an indication of both sensor data for determining the classification nature of each point on the path. The blending can be visual and/or optical.

Another embodiment is a program storage device that includes a plurality of instructions, the instructions are adapted to be executed by a processor of a computer, the instructions, when executed by the processor, conduct a process that generates a map which displays a set of geologic characteristics that correspond to the combined horizontal and vertical features, based on data at one or more points along a path. The method of this embodiment assigns a calculation that is based on the combined horizontal and vertical features centered at each point along the path to form a result for that point, assigns a visual indication of the calculation result for each point along the path, and assigns a validity measure to each point along the path, the validity measure being based upon the availability of data for the calculation so that changes in the results are discernible by an interpreter.

Another embodiment is a computer program product for generating a map that displays a set of geologic characteristics corresponding to the combined horizontal and vertical features based on data at one or more points along a path. The computer program product includes a computer usable medium having a computer readable program code embodied in the medium for performing a calculation using as input the combined horizontal and vertical features centered at each point along the path. The computer readable program code includes a first computer readable program code adapted for causing the computer to assign a computed result to each point along the path, a second computer readable program code assigned to calculate a validity mask for the calculation along the path, and a third computer readable program code assigned to provide the visualization of the path, the computed result and the validity mask.

Another embodiment is an apparatus for mining underground structures. The apparatus includes one or more sources, one or more receivers, a tool to mine in a designated place, and a feedback system relying on the data obtained from the sources and the receivers to maintain the tool in the designated place most productively. The feedback system controls the tool to recover a portion of a natural resource using information from a geo-operator. The sources and/or receivers can be controlled in real-time to modify the characteristics of the processing of the sources or receivers based upon the geo-operator to improve the quality of the natural resource. The source can be seismic, electromagnetic (such as electric and/or magnetic), gravity, and/or particulate. The receiver can be seismic, electromagnetic (such as electric and/or magnetic), gravity, and/or particulate. The tool can be a cutting tool, an excavation tool, a drilling tool or the like. The designated place can be a channel, a bed, or some other geological formation. The information from the geo-operator can be based upon the results of a geo-operator calculation. The information from the geo-operator can be control information, regulator information, or the like. The characteristic can be directionality, waveform, or some other characteristic.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates an irregular manifold of five seismic lines and the error resulting from conventional flattening which cannot be uniformly distributed on all of the seismic lines.

FIG. 2 illustrates a 1D-classification features made from voxel data.

FIG. 3 illustrates 1D-classification features applied to interpreting strata in geoscience.

FIG. 4 illustrates how 1D features can effectively flatten data when the absolute change in feature size tracks geology thereby resulting in classification.

FIG. 5 illustrates the notation for a 1D feature.

FIG. 6 illustrates the aggregation of 1D features into a 2D feature.

FIG. 7 illustrates the aggregation of a variety of 2D constructs into a 3D feature

FIG. 8 depicts the classification of each point of the path as a selection of the best representative eigenvector of the decision space.

FIG. 9 illustrates how the 3D-classification feature needs to be physically applied to a 3D path to search for natural resources.

FIG. 10 illustrates plan and perspective views of a geo-operator on a path that reveal the manner in which direction arrows lie tangent to the chosen path.

FIG. 11 illustrates in plan views the physical expanse of the geo-operator that determines the relative ability to detect the presence of natural resources.

FIG. 12 illustrates rotations and translations of the geo-operator during template-type matching with the geo-operator to indicate the presence of resources.

FIG. 13 illustrates a geo-operator used in a reconnaissance mode to detect hidden physical deposits of natural resources.

FIG. 14 illustrates a trap that can be idealized as an inclined right circular cylinder.

FIG. 15 illustrates the stages in a calculation algorithm for a geo-operator that can classify physical context for the idealized inclined right circular cylindrical trap.

FIG. 16 illustrates the geodesic changes in physical confinement of a natural resource.

FIG. 17 illustrates an application of the Onion-Layering Algorithm to determining the actual limits of physical confinement boundaries.

FIG. 18 illustrates the flowchart of the geo-operator based on the calculation of the geodesic of confinement of the resource.

FIG. 19 illustrates the interaction between classification boundaries and the classification results.

FIG. 20 illustrates hardware and software implementation techniques of the geo-operator device and system.

FIG. 21 illustrates the pseudocode necessary for the path tracking procedure that applies a geo-operator to the particular chosen path.

FIG. 22 illustrates an alternative embodiment of the geo-operator approach used to find the cardinality transformation necessary to perform a local flattening of data.

FIG. 23 illustrates the generic approach to seismic exploration and how the geo-operator technique can be used for improvement by feedback.

FIG. 24 illustrates the generic approach used in excavation and how the geo-operator technique can be used as the control element of the improvement by feedback.

The present invention may be susceptible to various modifications and alternative forms. Specific exemplary embodiments thereof are shown by way of example in the drawing and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF THE INVENTION

The invention solves many shortcomings of the prior art by producing a method of applying a calculation of seismic data along the path of a vein of geologically significant material in such a way that the geological information associated with the depositional play is preserved, thus obviating the need to flatten the data. The present invention also provides a tailorable method of yielding an indicator based on using 3D-classification features swept through a data volume and confined to a path to find natural resources.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The preferred embodiment of the geo-operator technique involves the sweeping of 3D-classification feature to perform a directed calculation through a data volume while being constrained to a path. The implementation of the technique can be effected as a device in hardware or software or any combination of hardware and software.

Essentially the method involves creating a desirable 3D-classification feature, creating a calculation algorithm that can be used to provide an output indication, and sweeping the feature operator through a data volume on a path, while aligning the operator direction to be tangent to a desired path. A 3D-classification feature is selected, based on the voxel data matrix corresponding to the operator extents in 3D, and a calculation algorithm is selected that will provide an output of the desired form. (Because a 3D-classification feature matrix is used as input, the output is capable of being a tensor output, as described below). An advantage of the geo-operator technique is that the calculation algorithm can be made nonlinear, which is a general requirement whenever the number of classification categories exceeds a relatively number (e.g., five). Another advantage is that non-seismic and seismic data can be fused in a quantitative manner to allow the combined effect on classification decisions to be included.

The following sections reveal how classification features are created in 3D and how the features are to be oriented during the calculation of the indicator output for this novel geo-operator technique. The benefits that accrue from using the technique in reducing computational load and improving classification capability are described, and exemplary methods of formulating algorithms for the calculation in the geo-operator are taught.

Evolution of 3D Classification Features

Classification features can be created in a simple means using the data typically available to a geoscientist. Typically, 1D (vertical) data is used in conventional seismic analysis. The methods shown here allow the creation of 2D and 3D-classification features based on physical characteristics of the dataset, by aggregating classification features from 1D into 2D, and aggregating 2D into 3D. Later it will be seen that the geo-operator technique has an advantage that the internal algorithm calculation provides a means to provide tensor output that can be associated with the path point under consideration.

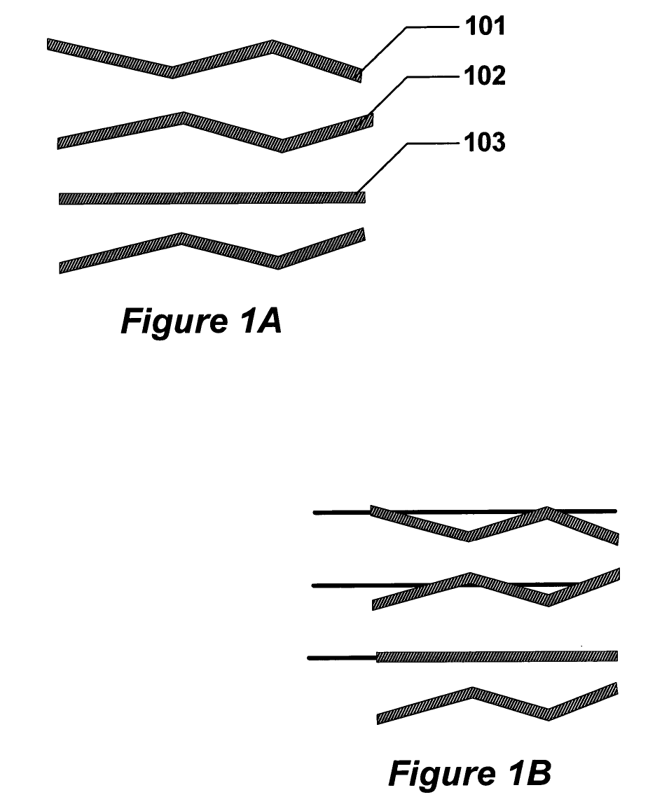

Turning now to a drawing which shows the impact of having to flatten data, FIG. 1A shows a two dimensional (horizontal versus vertical) slice of 3-D data, with three seismic layers corresponding to three different acoustic impedances labeled 101, 102, 103). Ordinary flattening in which a particular seismic line is used as a flat reference to which the position of the rest of the lines are adjusted, as shown in FIG. 1B by the corresponding transformed traces 101T, 102T, and 103T typically produces errors, as described here. A few peak points have been used to define the surfaces. Although this works for transforming surface 103 into 103T with little error as the reference line in this very obvious example, the same technique necessarily does not work for layer 101 or layer 102. This type of error occurs when customary fixed interlayer offsets are used: as can be seen for instance on 101 transformed to 101T, the error cannot be small over the whole horizon as is the case with horizons 103-103T.

Typically, what is done in 3D seismic work thus far is to one of four sub-optimum choices: flatten on one seismic trace and accept the errors on other traces, successively reflatten on a relatively large number of traces, or to give up and attempt to use calculations on unflattened data while accepting that the operators which are not aligned to geology consequently produce errors, or simply to move an operator along the Cartesian indexes of the data matrix and simply disregard all effects of the changing stratigraphy on the calculation.

These methods for dealing with the flattening problem are significant enough that the geoscientist most often resorts to employing only 1D vertical operators, moved simply along Cartesian directions (i.e., in one or two of the inline, crossline, or depth directions) to provide an approximation that might be valid in a very localized area. Another factor is that the literature does not address how to create or use 3D-classification features, other than to merely relying on a volumetric statistical calculation in a three dimensional sub-volume of the dataset. The paragraphs below indicate how 3D-classification features can be created and how they are used inside calculations to effectively solve the need for flattening.

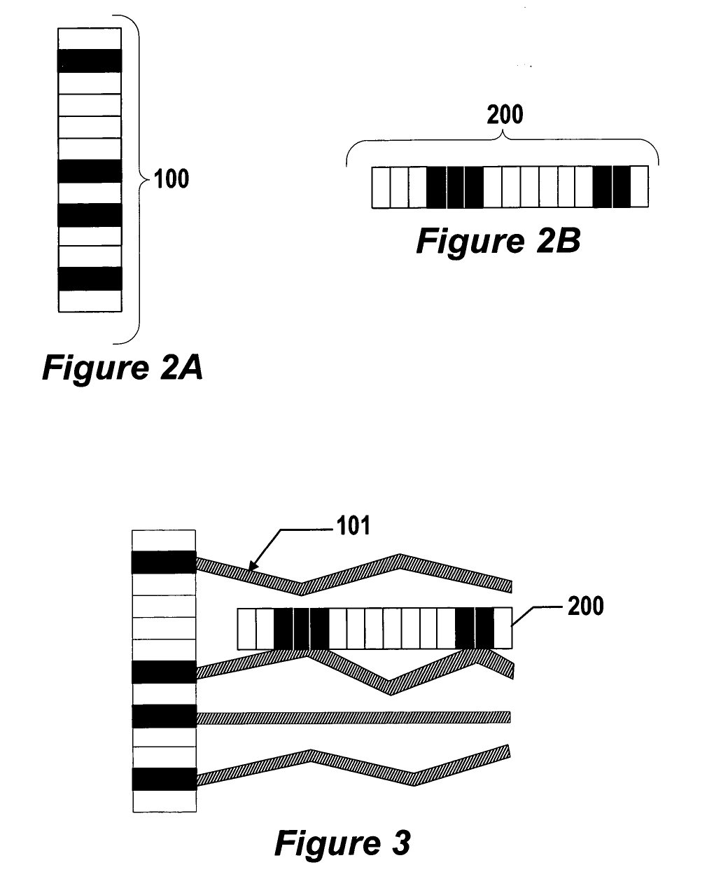

The progression of aggregating 1D features into a final 3D-classification feature requires the creation of horizontal classification features, and a discussion of how such features are used for classification. As discussed in the disclosures of Wentland, the vertical features are collections of the voxel data, fragmented from the original data and used for defining decision boundaries. For the purposes of this invention, no generality is lost if the vertical classification feature is simply considered a finite number of voxels in the vertical direction having specific values. This definition allows the horizontal classification feature to be defined by considering a finite group of voxels in the horizontal direction. If the vertical and horizontal 1D classification features are based on stratigraphic principles, they can be used in interpreting the acoustic layers visible in a seismogram to search a seismic volume, examples of which are shown in FIG. 2 and FIG. 3. FIG. 2A shows a vertical prototypical classification feature 100, which can be used to search a seismogram in depth. FIG. 2B shows a horizontal prototypical feature, 200, which can be used to search a seismogram laterally. Using a purely digital logic, in which a dark band denotes the presence of a seismic peak and a white band denotes a trough, a seismic volume can be searched by observing where the stratigraphic layers match with the bands of the feature. (Because acoustic layers will be contiguous, the presence of multiple bands in this simple case denotes physical thickness of stratigraphic layers.). In FIG. 3, these horizontal and vertical features can be shown to search by mapping whether the seismic section under consideration possesses or agrees with the feature at that point. The agreement of the presence of a specified layer can be accomplished by counting the number of agreements of the white bands and the number of agreements of the dark bands while taking into account the number of disagreements of the feature with the data. (This can be normalized as a correlation coefficient by dividing by the number of available bands in the feature). At the two locations shown where the features are positioned in FIG. 3, the bands of the horizontal and vertical features agree with the seismic data since a stratigraphic layer is present at each band of the features 100 and 200, and the output of a digital match correlator would trigger when the feature is place at these locations in the seismogram. A similar type of vertical technique is used when tying synthetic sonogram information available at wells (whose subsurface layers properties have been previously determined materially) to tie to acoustic layer information from seismic surveys (whose subsurface layers properties are only known from the noninvasive seismic waves of the survey). The use of these features in ordinary well tying may require some relatively minor stretching or compression (note that this vertically for well-tying, and would be vertically for a vertical feature and would be horizontally for a horizontal feature). However, the use of extraneous bands which are present in the data at the well but absent at the survey data location requires the interpreter to hypothesize the cause of the new layer which is absent at the well. Normally the well data can only be propagated away from the well a finite distance until such discrepancies limit the interpretation. The use of a fixed vertical feature (without relying on having to inject a “previously-unfound” layer) to typify a region based on the coordinates of its presence map is therefore a novel concept. The use of horizontal features is actually a further novel extension of this concept.

It can be appreciated that the use of fixed features such as shown in FIG. 2 would necessarily be sub-optimum when being applied to unflattened data such as FIG. 1A. The novel methods of this invention are use a geo-operator aligned with a path that identifies the changes in strata, or can be used to find a transformation that provides effective local flattening in a superior way to that shown in FIG. 1B.

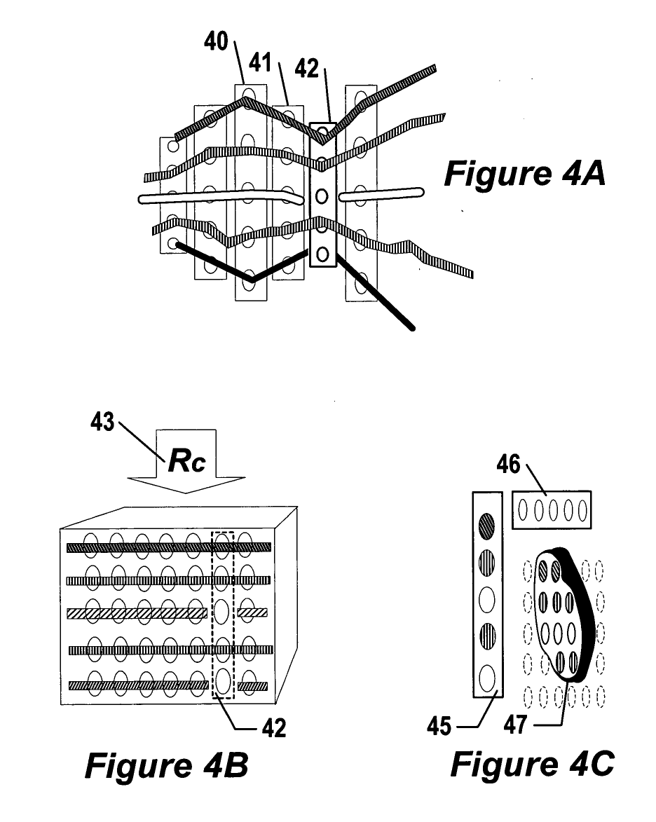

The result of using vertical and horizontal features to interrogate a region represents a coding or representation of the underlying seismogram. A significant piece of information in this mathematical representation of the seismic volume are the compressions and translations used to orient the horizontal and vertical features necessary to obtain correspondence with the seismogram. In FIG. 4, the bands are denoted by circles, to indicate that the feature is used to test the underlying seismic information, which has acoustic layers corresponding to a layered statigraphy of different patterned lines. FIG. 4A shows the outline of a vertical pattern (40) as it moves through several positions in which it is compressed to different degrees at 41 and 42 to maintain conformance with the stratigraphy exhibited by the data. It can be seen that the compression of the feature maintains the alignment of the bands of the feature to the statigraphy. In fact, once this mapping of the compression is accomplished, the cardinality or order of the bands within the feature can be used to reorder the coordinates of the stratigraphic lines from the original voxel indices to a set of relative indices. This form of transformation that reorders by cardinality is designated Rc, shown as 43. For instance, the stratigraphic lines that can be discerned by front-to-back rendering of a vertical slice of a 3D volume have the characteristic up-and-down appearance of FIG. 4A. Each voxel element represents a four dimensional quantity (with indices for inline, crossline, depth and seismic value). A display quality such as color is chosen to render the seismic value at a XYZ point in the display corresponding to an inline, crossline and depth location. The cardinality transformation Rc transforms the seismic information such that the data can be re-plotted as shown in a regularized form in 44 in FIG. 4B. FIG. 4B indicates how the vertical slice is a 2D entity as it represents a slice of a 3D seismic volume (with the crossline dimension into the paper shown shaded). The regularization performed by using the cardinality transformation Rc is accomplished by plotting the alternative coordinates of occupation of each row of the feature, the compression of the feature and the translation of the center position of the feature. The effect of using such a feature operator to track stratigraphy can be seen to effectively result in a flattening of the data in the cardinality space. In FIG. 4A and FIG. 4B, the data shown is a two-dimensional slice of a three-dimensional seismic volume. For this case as shown, the coordinate system using inline, crossline, depth basis coordinates is effectively transformed into a coordinate system using translation distance, crossline, and feature-band as basis coordinates. The feature shown in position 42 of FIG. 4A is also shown in FIG. 4B of the regularized data. FIG. 4C shows a vertical pattern with a specific encoding as 45. FIG. 4C also shows a horizontal feature with five band positions (46) and a three-dimensional feature (47) with ten band positions shown on the front surface and depth shown by the shadow representing the possibility of having band positions in the crossline direction. The specific band pattern shown in the vertical feature 45 of FIG. 4C represents a template key. The pattern shown in the feature 45 of FIG. 4C is not merely distinguished by the digital logic of dark versus light band, but is based upon desired seismic numerical values at the band positions. Indeed, the specific pattern shown in feature 45 of FIG. 4C can be seen to find a match at the feature positioned as 42 in FIG. 4A and FIG. 4B. The calibrative match between the feature when considered as a template key of 45 in FIG. 4C and the data feature in position 42 of FIG. 4A and FIG. 4B can be accomplished mathematically by analog or by weighted digital methods. The values of the bands of the feature may be specified by values, Boolean expressions of ranges or thresholds.

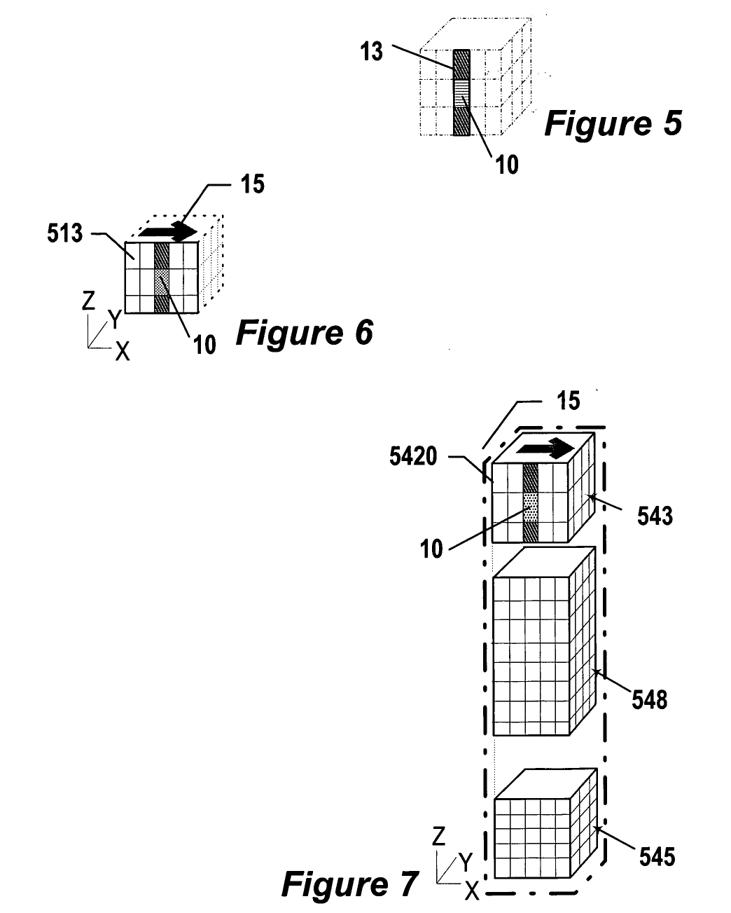

The creation of 2D and 3D features through aggregation of simple horizontal and vertical features is shown in FIG. 5, FIG. 6 and FIG. 7. An important concept in orienting 2D and 3D features is the use of a registration voxel and a direction vector. In FIG. 5, a feature labeled 13 is shown which actually may be considered a 1D feature, comprising in the case shown three vertical voxels, of which the registration voxel is labeled 10. The underlying rectangular seismic volume is depicted in dotted lines. For the purposes of illustration, the label 13 may be considered a denotation method for the type of feature, one voxel (inline) by three voxels (depth). This simplistic type of labeling is carried over to FIG. 6, which shows how a 2D feature can be made up of 1D features. In FIG. 6, the feature is labeled 513, signifying feature extents of five (inline) by one (crossline) by three (depth), which can be seen in the label 5_{—}1_{—}3. This feature may be made up of a collection of vertical features such as object shown in FIG. 5. The feature shown has one particular 1D feature highlighted, (similar to that of FIG. 5) which is embedded in the vertical face, and from which the registration voxel 10 can be used to register this 513 feature. In addition, a direction vector labeled 15 is provided. This direction vector and the registration voxel, which are required parts of the geo-operator, form a unique orientation for the geo-operator. The direction vector indicates where the geo-operator will be moved next in the path calculation. The feature 513 may be considered to have been aggregated from other 3_{—}1_{—}3 and 2_{—}1_{—}3 component features (being assembled as 5_{—}1_{—}3=3_{—}1_{—}3+2_{—}1_{—}3 or assembled as 5_{—}1_{—}3=2_{—}1_{—}3+3_{—}1_{—}3). FIG. 7 shows how aggregating individual 2D and 3D features can make a composite 3D feature. In the simplistic numbering system (used solely for teaching purposes) object 5420 denotes a feature having inline extent 5, crossline extent 4, and vertical extent 20. Hypothetically, aggregating features 543, 548 and 545 has made up this feature. The vertical extent (which is 20) of the overall feature, labeled 5420, is larger than the sum of the component features 543, 548, and 545 (3+8+5=18<20), which indicates that some of the intermediate voxels of 5420 are not used in the calculation of the geo-operator in this case. (For instance assume that the interpreter feels the effect of a layer of voxels between 543 and 548 and between 548 and 545 is immaterial in the calculation. Such voxels can be caused to have a null effect on the calculation). The registration voxel for feature 5420 is labeled 10, and the direction vector is labeled 15.

Sweeping a 3D Feature in an Oriented Calculation

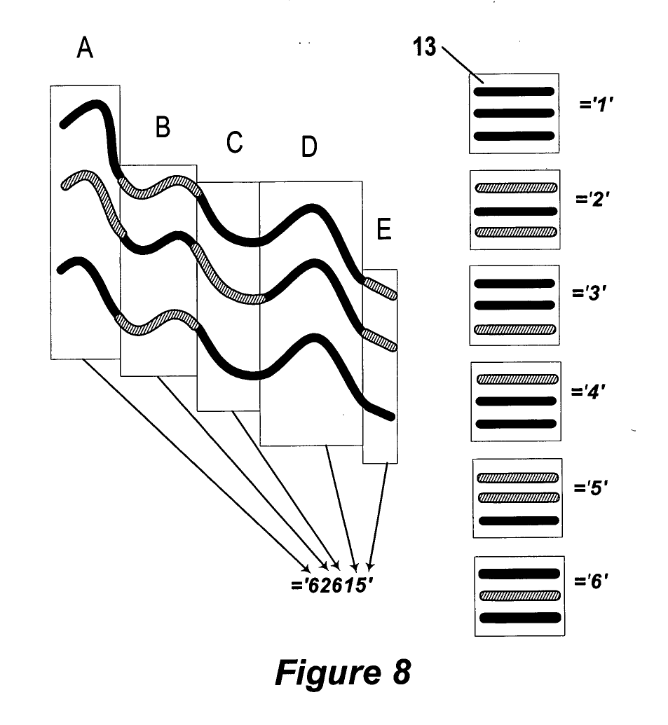

As discussed above, the features of FIG. 4C can be thought of as a template key for prototypical features or eigenvectors of the classification space. The process of sweeping the feature through the seismic data volume together with obtaining an output value of the match can be considered to be the application of a feature operator or using the feature and the resulting calibrative calculation as an operator. Many other mathematical operations are potentially available to provide an output indication of the presence of the feature template key within the seismic data volume, including statistics and linear and nonlinear transformations. The output of the mathematical operation may be a scalar (a tensor of order 0), a vector (a tensor of order 1) or simply a tensor (of arbitrary order). The feature template key together with the arbitrary mathematical operation used to form an output, along with a direction vector to show where the feature will be moved next, can be called a geo-operator. Here the calibrative operation can be performed in a number of ways, and no restriction just to ordinary mathematical correlation is meant to be implied. While there may only be a countable denumerable number of such features, there may be a large number of ways of calculations that can be used to indicate a quality of the underlying physical phenomena on the path. Although it may appear that the geo-operator calculation provides a detection of the change in an underlying physical property, it is more correct to consider that the geo-operator output classifies the physical property at each point along the path as shown in FIG. 8. In this sense when all possible geo-operators are used along the path, the resulting calculations allow each point on the path to be characterized in terms of goodness-of-fit as to which eigenvector of the decision space best characterizes the path point. Thus, the function of the geo-operator is as a orthogonal basis vector of the decision space which when operating against the data along the path, produces a dot product output which indicates its relative presence at each point. It may be easiest to illustrate this with a planar example using a 1D vertical feature. This is exemplified by FIG. 8, which shows on the left, three traces of seismic voxel data on a path ABCDE. The three lines are examined with a vertical classification feature. The feature can have be any one of 6 prototypical eigenvectors as shown on the right side of the figure. For instance, object 13 (which is a representation of a vertical classification feature of one unit inline and three units in depth, as denoted also from FIG. 5) can be seen to be a particular eigenvector in which the seismic value the same for all three layers. If a geo-operator can be created in which the output for path points corresponds to one of these six eigenvectors, then the geo-operator will function as a classifier of the physical property along the path. For instance at position D the output corresponds to object 13 and the calculation outputs a symbol “1”. Using the above-identified approach, the output of the geo-operator along ABCDE results in the encoding “62615”. If the hydrocarbon or natural resource indication is the symbol “2”, we see that point B on the path has an indication of the desired resource. In a very simplistic way the search for the natural resource can be converted to detecting the desirable “2” in the output. The geo-operator actually classifies the points on the path according to the separability of the eigenvectors used. (Classification being the determining the membership of a point amongst a group of classes based on point qualities that differentiate the classes, whereas detection of a quality is often taken to specifically mean using experimental determination of the existence of the quality. Clearly, in this case the geo-operator can be viewed as allowing a classification problem to ultimately be solved as a detection problem for the natural resource indication. Because a number of qualities must be found before a valid direct natural resource indication can be made as a detection, a number of geo-operators may be necessary to be employed to provide an indication of various physical features of classification.)

This is an important point in that one of the novelties of this invention is that it provides a method of tying the classification boundaries to physical path points. Much of the existing work in pattern recognition has been done by relying on statistical methods. This is done to overcome limits of linear separability of points. (One can imagine points on a plane in such density that only circles around each group of point could separate them, which is a widely observed example of non-linear separability. In practical cases such a highly nonlinear transformation has to be employed to allow separation of the classes to uniquely contain a point and thus allows the point to be classified.) The simple dimensionality of the seismic data needs to be increased by aggregating the data into higher dimensionality seismic-derived classification features to allow the separation of the underlying data into the classification categories to be more easily performed. Once a clear separation is available in the decision space, the desired natural resource area can be differentiated from all the remaining background areas as a detection decision. Unfortunately, if statistical and probabilistic processes (including neural net approaches) are relied upon to form associations in a purely mathematical sense, a tie to the underlying physical phenomena may not exist. The lack of a tie results because reversing the transformation from physical space to classification space is not one-to-one (as mentioned the complexity of practical cases generally requires nonlinear mappings which by their definition do not have a one-to-one reverse transformation over a large domain). Consequently, the benefit of the geo-operator approach is that it maps the intersection of the classification decision boundary directly onto the path. A natural resource such as a hydrocarbon can be found by using a number of geo-operators to provide derived characteristics in addition to the basic characteristics of the seismic, rock-physics or other sensor data. In the case of hydrocarbons, which are lighter than the materials they displace, and which must be trapped by an exterior physical matrix, there are a number of elements that must be present for the natural resource to result in a pay region. These elements are the following. There must be a formation of a hydrocarbon producing source material. There must be a chimney with the qualities sufficient to allow the percolation of the hydrocarbon. There must be a formation of a material with qualities sufficient to be impervious to the hydrocarbon. The materials that the hydrocarbon displaces to fill the trap must only be present to a certain proportion. The seal integrity must be maintained along the trap to store the hydrocarbon. Geo-operators can be created to indicate the presence of each of these elements along a path. A key feature of the geo-operator is that it is designed to follow a trap or vein structure, thus improving the value of the statistics generated at each point on the path. Additionally, without loss of generality or restriction, all of these geo-operator calculations can be calculations into a single “super” geo-operator that performs a direct natural resource indication of the presence of a pay-region on a path. However, the benefit of the geo-operator approach is not limited to the case where the single operator using all the elements is available.

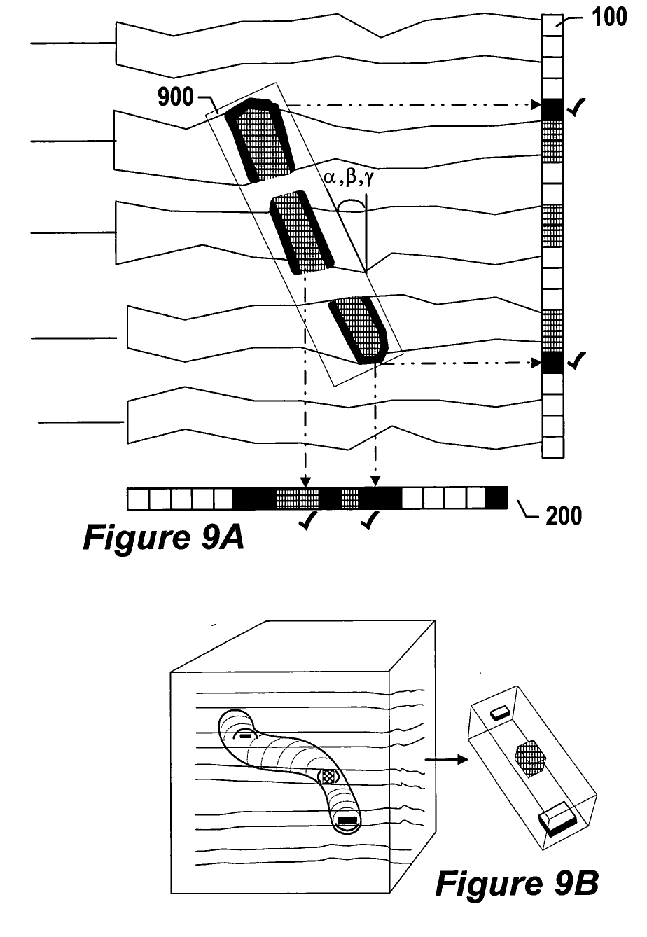

The additional factors needed for sweeping in 3D can be considered using FIG. 9. In FIG. 9A an inclined trap (with approximate body angles α, β and γ) is silhouetted by the seismic returns. The outline of a 3D-classification feature (900) can be used to approximate the area of the location of the trap in this 2D slice of the 3D data. A vertical feature (100) and a horizontal feature (200) are shown. Note that the quantization granularity for the vertical and horizontal feature is finer than that used in FIG. 2. The checkmarks on the voxels indicate that these particular voxels show structure, corresponding to either the top trap, the bottom trap or the contained natural resource. Note that the slice orientation relative to the actual α, β and γ body angles of the trap would cause the effectiveness of the 1D feature, (and a 2D feature made from simple pasting of such 1D features) to be slice-orientation dependent. This is a serious limitation of the 1D and 2D classification feature: To observe structure and compensate for the reality of the 3D world, a number of such features at different orientations must be used, or a highly nonlinear algorithm must be used to decipher the calculation result. A more realistic view is shown in the 3D portrayed in FIG. 9B. On the left-hand side of FIG. 9B the actual cylindrical trap is superimposed on the seismic voxel data. A 3D operator using the minimum number of voxels is shown on the right-hand side of FIG. 9B. Looking at the left-hand side, we see that the seismic data captures the top of the trap, the natural resource in the center of the trap, and the bottom of the trap. Knowing that these are required elements we construct the 3D-classification feature on the right-hand side, (in this case choosing only to use specific voxels and requiring them to have specific values as shown by the shading) to be the classification feature. It can be seen by those skilled in the art of geoscience, that this feature could be used to find this particular type of vein of natural resource. The whole vein does not have to be captured in the classification feature, particularly if the feature can be moved along the path of the structure, which is an advantage afforded by the novelty of this invention.

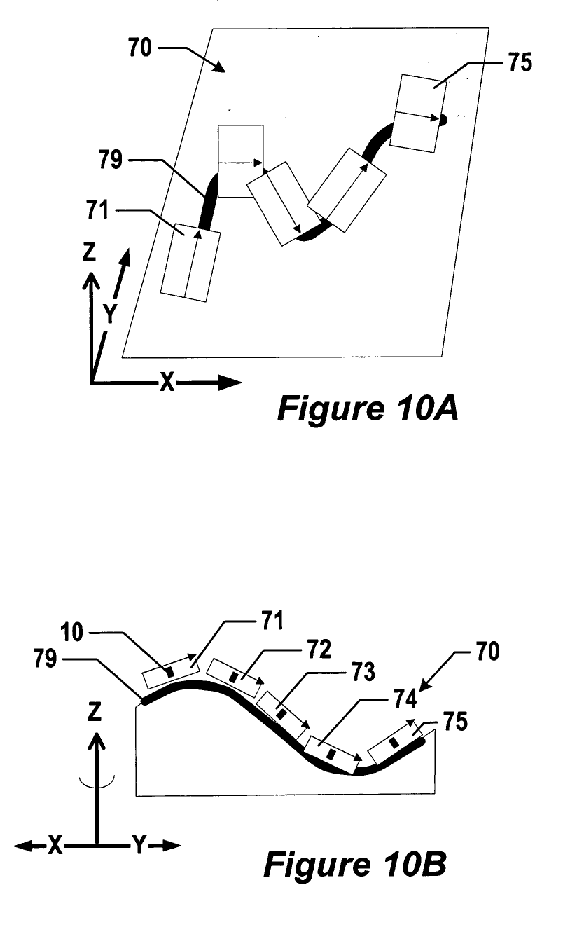

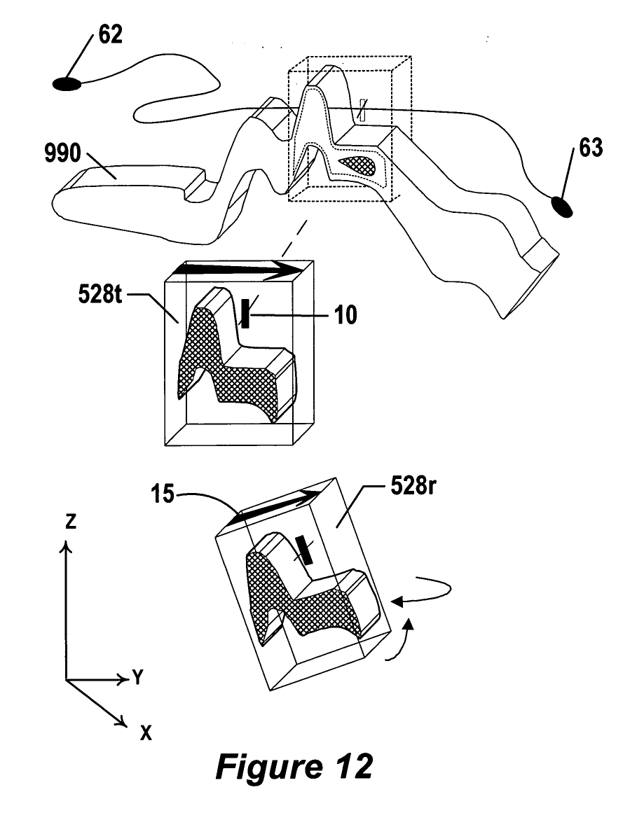

In the preferred procedure, the geo-operator will follow a 3D trajectory as depicted in FIG. 10. FIG. 10A illustrates a plan view of the 3D space, the path and the geo-operator traveling along the path. FIG. 10B shows the operator on the path in side view. The path (79) in the 3D space lies on a particular surface (70) of the 3D space. The direction arrows lie tangent to the direction of the path 79 from its start point to its end point. The operator conforms to the path as shown in FIG. 10B at successive positions labeled 71, 72, 73, 74 and 75. In FIG. 10B the registration voxel (10) is discernible. (The actual process used in employing the geo-operator concept on a 3D path to search for natural resources in subsurface deposits, will actually involve translation, rotation, and interpolation of a directed calculation tangent to the path as depicted in FIG. 12.)

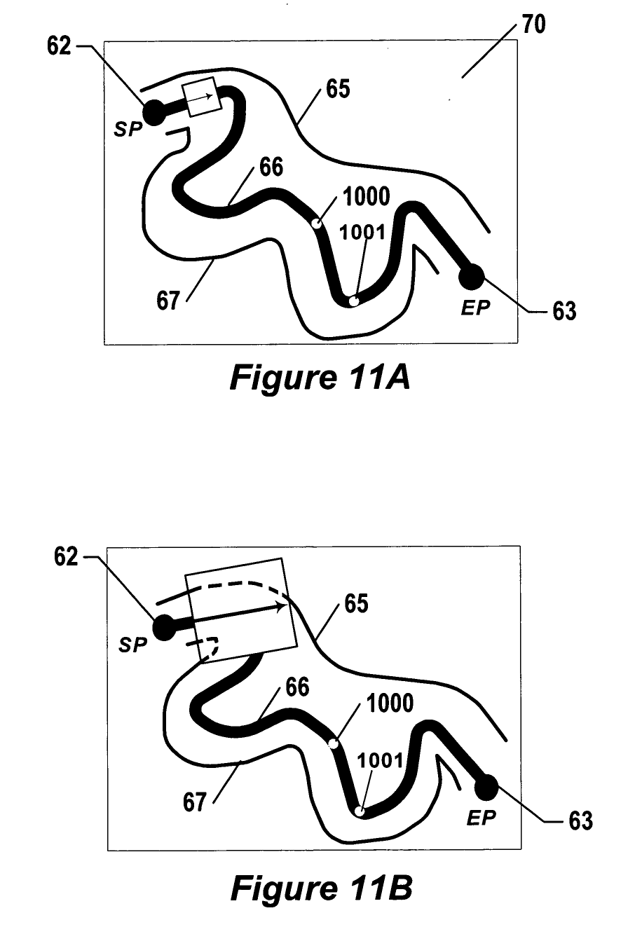

In keeping with one of the principal objects of the invention, FIG. 11A and FIG. 11B show in map or plan view how the geo-operators of differing extents can be used to detect the presence of significant changes on a specific path. In FIG. 11A, the operator 60 is moved during the calculation from the start point at 62 to the endpoint 63. (Recall that FIG. 1 actually shows only a feature, whereas FIG. 2 depicts a geo-operator since a direction vector 15 is also provided.) Along the specific path 86 between points 62-63 in FIG. 11, the geo-operator will encounter regions of geologic significance 1000 and 1001 in which a recoverable natural resource may be detectable when the geo-operator encounters these points. Adjacent non-pay regions or veins, which if they were to be included would contaminate the output indication of the geo-operator, are labeled 85 and 87. The difference between FIG. 11A and FIG. 11B is that the size of the geo-operator affects the ability of the calculation resulting from the mathematical operation to clearly indicate the presence and localization of the natural resource. This is because the size of the operator 60 in FIG. 11A and the operator 61 in FIG. 11B determine how much overlap of the undesired regions (65 and 67) occurs. Notice also that the large size of the operator 61 will cause the indications from 1000 and 1001 to be less pronounced since the operator will include a significant amount of the path adjacent to these points. Additionally the operator 61 is larger than desirable since it will smear the two pay regions 1000 and 1001 together.

The form of the invention shown in FIG. 12 as it travels along the path 62 to 63 provides for a matching of physical property (labeled 990). The actual path from 62 to 63 corresponds to a stratigraphic or seismic surface along which the geo-operator calculation is to proceed. The physical property will have some linear or nonlinear dependence upon the seismic data that can be detectable by the particular calculation used in the geo-operator. In FIG. 12 the physical property 99 and the feature 528t are colored in grayscale proportionately to the value of the voxel. The desired voxel values, which indicate a pay region for the physical property, are shown in the geo-operator labeled 528t where the t-suffix represents an operator aligned to the basis vectors of the coordinate system (except for a translation). That is if the voxels encountered along the path moving from points 62 to 63 have the values shown in the feature of 528t, the calculation performed by the calculation of the geo-operator will show an indication of a pay region. In FIG. 12 it is seen that at the particular point along the path where the operator is being considered there is not a match (since, in this simple depiction of the seismic values, the grayscale colors do not match), and hence not a match in the required voxel values to cause the calculation of the geo-operator to produce an indication of pay region at this point. The particular voxels used in the calculation may have stratigraphic or structural importance in making the calculation significant from a geoscience standpoint. The form of the calculation is based on having a distinct indication of where hydrocarbons or other natural resources are present. It is to be stressed that the values of specific voxels are transformed by the calculation of the geo-operator to yield an indication of pay region. It is the combination of the calculation (which can be tuned by the interpreter) and the specific feature with voxels at specific locations within the feature that provide this transformation. Object 528r is a rotated version of the feature, being denoted by an r-suffix. It is important to realize that in order to maintain the direction vector 15 strictly tangent to the path, the orientation of the operator may have to be rotated from the basis set of the coordinate system as it moved along the path.

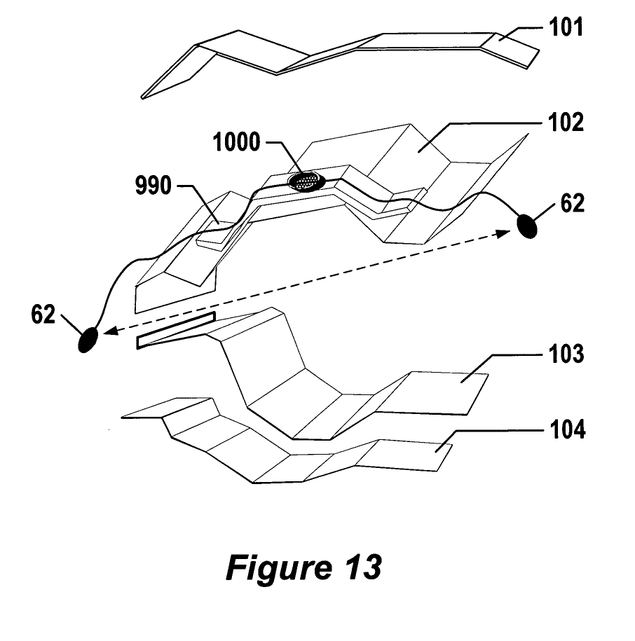

As a main feature of the present invention, it is the ability to confine the calculation to a desired path such as that shown in FIG. 13. The objects 101, 102, 103 and 104 show acoustic layers that reveal the local stratigraphy. Between points 62 and 63 there are multiple paths possible (two of which are shown, the intended calculation path that lies as a solid line along surface labeled 990, and a direct straight-line path depicted as a dashed line). An interpreter might be inclined, perhaps based on the local dip and strike angles present in this data, to use a path such as the solid line that passes near the surface or property labeled 990. The interpreter may feel this way due to the physical confinement that is necessary to trap natural resources, which is interpreted to be present from the convexity and placement of nearby surfaces. Thus, the natural resources may be found along the layer labeled 102. The object 990 may represent the output of a particular geo-operator in revealing what physical properties are present along the path from 62 to 63. (It can be understood by this that this particular geo-operator through the calculation operating on the seismic data creates a representation of the physical property shown as the surface labeled 990. When the output of the calculation is a scalar, obviously each voxel along the centerline of the path has aggregated to it an additional dimension, that of the result of the output of the geo-operator. When the geo-operator output is a vector in 3D space, there can be 4 additional dimensions aggregated: magnitude, and three direction cosines, for each property considered. When the calculation result of the geo-operator has greater dimensionality, such as resulting in a tensor output, the additional dimensions aggregated at the path point will be correspondingly higher. Each geo-operator that is used to describe a property along the path can accrue more dimensions at the path points. Thus the use of geo-operators can hyperdimensional encoding the physical properties along a path, as a higher order representation using derived-seismic information to augment the underlying seismic information. Thus, the surface 990 may also be viewed as a portion of the hyperdimensional representation of the analysis space at that point on the path. Object 1000 is a deviation of the output of the geo-operator indicating a pay region. By detecting a significant change of the geo-operator output at this point, the interpreter can discern the presence of a pay region.

Two methods, among others, can be used for the calculation of the geo-operator. One is to use a minimum required number of voxels needed to provide separation of the data points into classification categories. The other is to use a calculation that is tied to the expected geodesic change of physical structure. Later it will be indicated that one of the key advantages of an embodiment of this invention that both of these techniques to form a geo-operator can be combined.

Geo-Operator Using a Minimal Number of Voxels

Three-dimensional features of arbitrary shape can be expressed in terms of more standardized features with parallelepiped shape as shown in FIG. 4C. The arbitrarily shaped three-dimensional feature 47 of FIG. 4C is a specific case of a feature contained in a larger, three-dimensional volume. (If the bands outside of the arbitrary shape are weighted with nulls or zeros to discount them, the remaining bands in a larger volume can be used in an equivalent mathematical operation to form the same output indication.) Thus, the use of operators with parallelepiped shape can be considered without any loss of generality.

The actual import of using such a parallelopiped is that not every voxel of the operator extent need be used. In this view, the operator size is given by the extents chosen, but one or more calculations can be provided, depending on which voxels are accessed by a calculation. Thus, the active portion of the geo-operator is the portion accessed by the calculation. In the case of the conventional vertical feature 100 or the newly defined horizontal feature 200 of FIG. 1A, the active voxels might be the dark bands while the white bands might not be needed in the calculation. This geo-operator calculation technique can reduce the computations needed for large datasets. (The classification results thus obtained may be dependent upon the degree of separability of class membership as discussed below in the section entitled “Benefit Achieved From Tying Classification Decision Boundaries to Physical Paths.”) If the calculation algorithm chosen relies on determining an indicator for the presence of the darkened voxels in a simple case for instance, one algorithm may be written as

$$C ( p , P ) = \frac{h - k}{h + k}$$

where C is the calculation output (in this case a scalar);
p is the point on the particular path, P; and
h voxels are found to be dark, k are not darkened, and the total number of voxels in the feature that are intended to have been dark is h+k.
   (Note that if a more complex algorithm were to be chosen, such as with tensor output, the parameter list for the calculation algorithm might include an arbitrary direction vector, V, as in C(p,P,V).) Using the calculatio in the equation shown here, the geo-operator is in fact comprised of the feature (given by the shape chosen for which of the total number of h+k voxels were expected to be dark), combined with the calculation algorithm, (here given as the equation C(p,P)) when confined and directed along the path. This is an example chosen for illustrative purposes only; many other algorithms are possible and the technique is not limited to this example method of formulating the algorithm.
   Geo-operator Based on Physical
   Context

This type of geo-operator can be illustrated for the case of hydrocarbon exploration. In this case, the voxels selected are chosen because of their ability to delineate actual structures.

The elements needed for hydrocarbon exploration are quite specific. The elements include
1) a top seal
2) a bottom seal
3) a chimney
4) a source rock

All of these must be present to produce, trap, and maintain a hydrocarbon pocket. The impact on exploration success for each of these factors is well known. (See for instance the fourth and fifth patent drawings of Dablain et al, U.S. Pat. No. 6,587,791). These various elements (1-4) by their presence are a condition on the probability of successful exploration. Thus the calculation algorithm, when designed to detect one or more of these structures, maps the conditional probability of the structure by the classification decision boundaries found using the geo-operator technique.

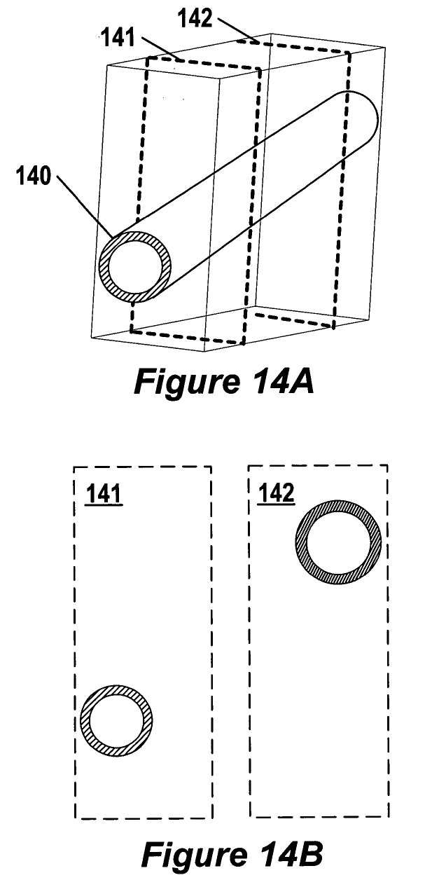

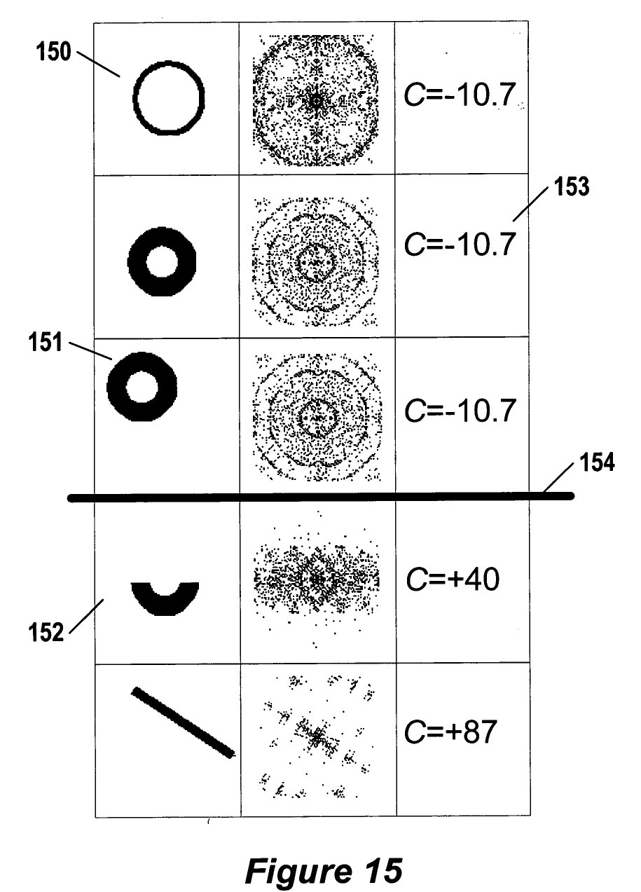

The same calculation algorithm C(p, P) as discussed above for illustrative purposes could be considered for this case. However, a calculation algorithm can be based on the ability of the geo-operator to elicit physical context. Consider an elementary geometry for an idealistic trap such as a right circular cylinder having a finite wall thickness. Since the trap is a required element of the physical context, the easiest algorithm that can identify the presence of the required geometry is an example of a technique that can be applied for the geo-operator. If a statistic can be created to provide the indication, then it can be swept along the path to elicit the required physical context. Considering a parallelepiped feature in a perspective view as shown in FIG. 14A, if the slices are created perpendicular to the path, which is taken coaxially to the cylindrical trap, the cross-sections may be viewed as 141 and 142, depicted in FIG. 14B. It can be shown by those skilled in the art of digital imaging that the shape of the two-dimensional slice is preserved under Fourier transformation. FIG. 15 shows a number of two-dimensional slices (such as 150, 151, 152) of a structure in the left column, their scaled double Fourier transform in the middle column, and a algorithm calculation with the results in the rightmost column (such as 153). (Comparison of 150 and 151 indicates that this method of transform has been chosen since it makes the transform result independent of the idealistic trap thickness and position). The calculation algorithm chosen is to take the sum of the scaled double transform and its inverse.
C(p,P)=S(fft(fft(D(p,P))))+S(fft(fft(D(p,P))))⁻
where D is the data at a point p on the path P; and
S is the scaling factor.
   This mathematical construction is used since it is illustrates using this simplistic example that such construction can be made to detect the seismic data's confirmation that a trap of this type has integrity at a point on the path. As seen in the rightmost column, the decision boundary 154 can be chosen to separate slices whose calculation output (negative values) indicates that the cylinder integrity is preserved as opposed to those below the boundary (such as 152 which have positive values resulting from the calculation) and whose lack of trap integrity is due to the nonclosed formation shown for the corresponding slices shown in the left column. The geo-operator thus formed from this algorithm can be used to indicate if the path chosen by the geoscientist has merit for this type of trap. While a very simple classification problem having only a few classes was used for illustrative purposes, those skilled in the art would be able to extend the operator of this type, and no loss of generality is incurred. In this type of geo-operator, where the mathematical process that produces the output result is somewhat intricate, the separation of the geo-operator into a feature and a calculation algorithm is less definite, and the whole geo-operator may be viewed as the 3D-classification feature.
   Geo-operator Using Geodesic of Physical Changes

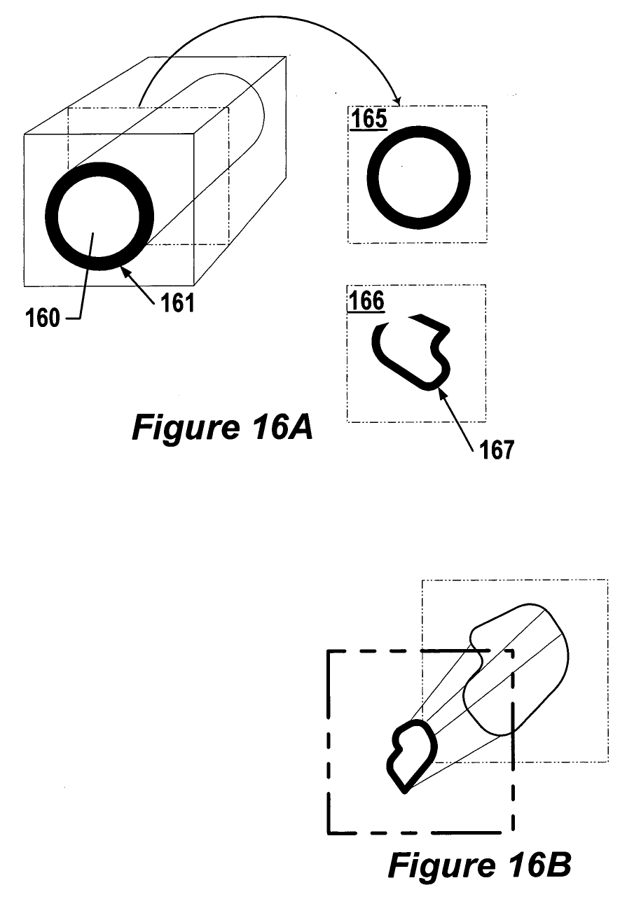

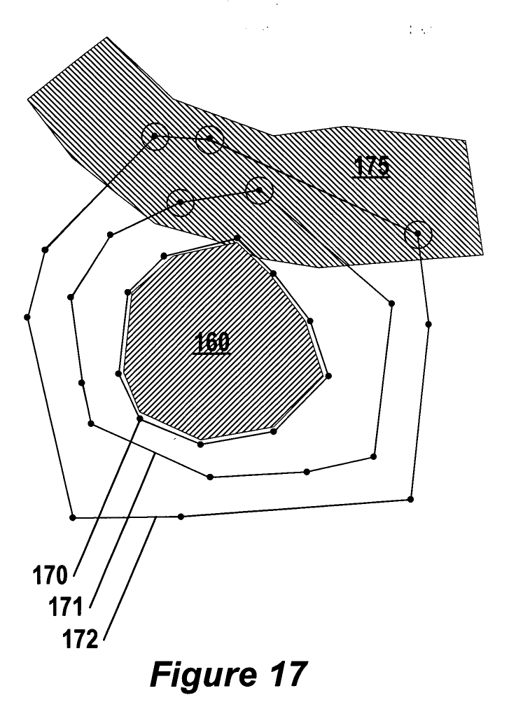

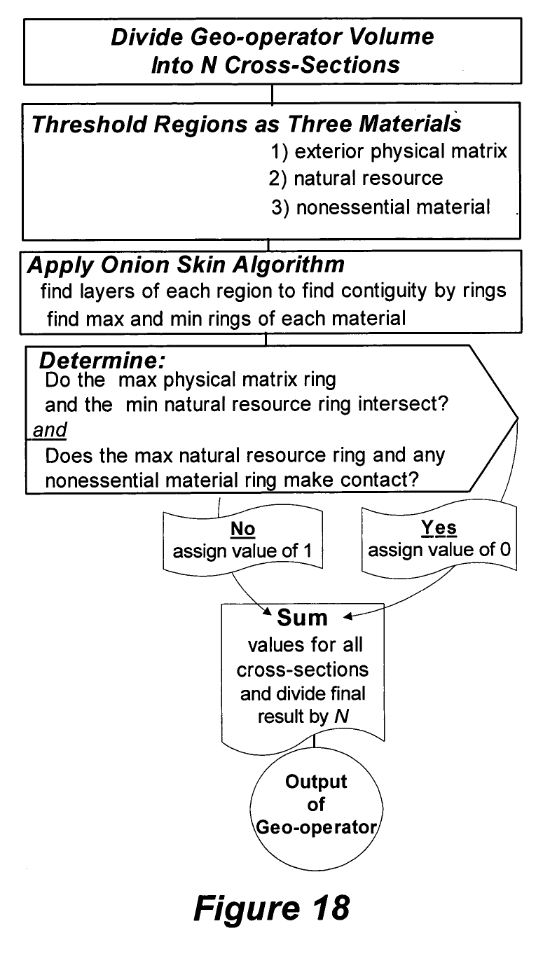

In a preferred embodiment, the calculation of the geo-operator can be based on both physical context and minimum number of voxels. In this way, the geo-operator calculates the minimum representation in the feature needed to provide physical context. Turning now to the construction of the calculation of the geo-operator, FIG. 16 shows how the voxels within the data volume of the geo-operator reflect the physical nature of resource confinement in a vein. FIG. 16A shows a natural resource (160) confined in a vein due to the exterior physical matrix (161). Note that the exterior physical matrix far removed from the natural resource is not needed in the calculation, since we are interested only in the geometry of containment of the natural resource. The calculation portion of the geo-operator could be performed by a simple calibrative process by which the values for exterior physical matrix and natural resource are calibrated with those found in the seismic volume at the path point using a specific cross-sectional geometry. However, this would assume a fixed cross-section. A vein cross-sectional change as shown by the change illustrated between cross-sections labeled 165 and 166 would affect such a simple correlation. It may be necessary for this case actually to detect mathematically detect whether the exterior physical matrix actually produces a confinement of the natural resource. Tracking such a vein confinement actually is part of the contextual information that a skilled interpreter uses to detect regions that have the potential for further investigation. Using mathematics to detect the confinement is straightforward. By the Jordan Curve Theorem, any continuous simple closed curve in the plane separates the plane into two disjoint regions, the inside and the outside. Therefore, for the natural resource to be confined, its curve must be continuous and simple (not double back on itself to form multiple pockets). Using the mathematics such as Graham's approach to find the limits of the boundary (the “hull”) which is well known to those skilled in the art of computational geometry, the boundaries for the natural resource (160), as well as the hull of the exterior physical matrix that confines the resource (161 in FIG. 16A) can be found. It is important to note that it is the inner boundary of the exterior physical matrix that must be complete and closed in order to confine the natural resource. For the cross section labeled 166, it can be seen that the boundary is incomplete, since there is a layer of nonessential material that touches the natural resource and breaks the envelope of the physical matrix. For a natural resource such as a hydrocarbon, which would need a ceiling to trap the hydrocarbon, the expected natural resource (labeled 160) indicated by the seismic value chosen would not correspond to a trapped hydrocarbon. Thus, a simple method of obtaining this particular geo-operator for a hydrocarbon would be to determine the percentage of the cross-sections of the geo-operator that have a closed boundary for the exterior physical matrix. A difficulty is that a fixed geometry may not persist over the cross section of the vein, as shown in FIG. 16B, where the cross section actual changes with the scale of the cross section, along the vein. However, the mathematical tools required to deal with this are all available from ordinary computational geometry. These include the use of decompositions of the regions of physical matrix, natural resource and nonessential materials by use of the Onion-Layering Algorithm, and the calculation of the intersection of convex polygons. FIG. 17 shows how the Onion-Layering algorithm, a counting technique used to determine set membership, is used together with polygon intersection to determine the integrity of the physical matrix trapping the hydrocarbon natural resource. The object 175 is a hypothetical outline. Consider at first that it is simply some arbitrary line. The Onion-Layering Algorithm finds the connectedness of the voxels in the physical matrix that are trapping the hydrocarbon to be represented as layers (170, 171, 172). Each of the black dots on the layers 170, 171, and 172 represent voxels that are occupied by the physical matrix material that can serve as the confinement for the natural resource material. The line labeled 170 connects those physical matrix voxels that are immediately adjacent to the natural resource (160, also as previously denoted in FIG. 16). Layer 172 is represents the maximum physical matrix ring around the natural resource. In the above-identified case, it is seen that the physical matrix voxels form layers that confine the hydrocarbon. Next, consider the case where the object labeled 175 is actually the nonessential material which cannot confine the hydrocarbon, and those black dot voxels which have a circle drawn around them are now actually part of other layers which define the connectivity of the nonessential material. If the nonessential layers do contact the natural resource region (that is if their boundaries share common edges) as shown, by the reasoning for this hydrocarbon geo-operator the calculation needs to output a diminished value, since it means the trap integrity has been violated. Because the onion-layering algorithm shows how to connect up contiguous voxel regions of each material property as a set of layers, and because the intersection of the layers can be easily detected by intersecting the polygons that the layers represent, the calculation present in this geo-operator is fully disclosed, as expressed in FIG. 18, which shows the steps in calculating whether a given cross-section has a closed exterior physical matrix boundary and how the output of the geo-operator in this case is calculated to be a percentage that indicates degree of confinement of the hydrocarbon natural resource. This method of formation of a calculation geo-operator using the geodesic of physical change has been using the Onion-Layering Algorithm and the Jordan Curve Theorem is provided for illustrative purposes but no limitation to the method is implied, and other techniques can be used to achieve the same result of this invention.

Benefit By Reducing Number of Computations

One of the purposes of the calculation within the geo-operator is to reduce the computation load of detection of leads, which might have further geoexploration potential. It is understood by those skilled in the art that it is desirable to economize the number and maximize the speed of comparisons between the feature voxels used by the geo-operator and those of the seismic data volume. Almost all of the current techniques use a volumetric comparison of every point. Some of the current techniques even require mathematical correlation over a large number of voxels in order to come up with a measure for each point or event that is considered, thus requiring a total calculation size many times greater than the number of voxels in the seismic data volume. For example, Alam's method requires a calculation at each event point of a waveform that is detected along a vertical seismic trace. One of the objects of the present invention is to form the calculation of the geo-operator in such a way that the computation uses the minimum number of operations to achieve the detection of the desired classification outcome. It can be seen that this is antithetical to the neural net approach (such as those of West, Bishop and West) in which the training set is used as the priming information to form a basis in which the vector of the actual test data can be expressed. This is because a sufficient neural net dimensionality must be found (sometimes by trial and error) to have enough completeness to capture the variations in the training set. There is no guarantee that the actual test data will have this degree of dimensionality and it is a matter of discovery for the outcome of the neural net method to explain whether the actual test data still represents membership in the original training set or whether a deviation has occurred.

Benefit Achieved from Tying Classification Decision Boundaries to Physical Paths

It is understood by those skilled in the art of classification that classification is a form of distinguishing classes or of categorizing the underlying data. Classification enables the separation of the data points into non-overlapping categories. Each separation of a voxel into one of two categories actually represents four possibilities:
1) That the voxel actually is a member of the desired category and by the classification process is correctly included in the desired category.
2) That the voxel actually is a member of the undesired category and by the classification process is correctly excluded from the undesired category.
3) That the voxel actually is a member of the undesired category but by the classification process is incorrectly assigned to the desired category.
4) That the voxel actually is a member of the desired category but by the classification process is incorrectly assigned to the undesired category.

For the purposes of this invention, the classification results 1 and 2 above can be called true positives and true negatives, respectively. For the purposes of this invention, the classification results 3 and 4 can be termed false positives and false negatives, respectively. (Classification result 1 is analogous to the “correct detection of target” case in radar or sonar work, while classification result 2 is analogous to the “correct call of no target” in radar or sonar. Classification result 3 is analogous to a false alarm in radar or sonar work, and classification result 4 is analogous to a “missed detection” in radar or sonar work.) For an assessment of the effect of false positives and false negatives on the overall probability of net classification can be calculated by the well-known Yule's Rule. The effect of false positives and false negatives can be seen by assessing the overall probability of net classification by dividing the number of good results by the total number of results.

$${P}_{onc} = \frac{{N}_{ci} + {N}_{ce}}{{N}_{ci} + {N}_{ce} + {N}_{fp} + {N}_{fn}}$$

where
N_{ci} is the number of correct inclusions
N_{ce} is the number of correct exclusions
N_{fp} is the number of false positives
N_{fn} is the number of false negatives.
The actual effect of false positives and false negatives on changing the overall probability of net classification can be assessed using calculus as

$$Δ {P}_{onc} = \frac{\partial {P}_{onc}}{\partial {N}_{fp}} {N}_{fp} + \frac{\partial {P}_{onc}}{\partial {N}_{fn}} {N}_{fn} = - \frac{( {N}_{ci} + {N}_{ce} ) ( {N}_{fp} + {N}_{fn} )}{{( {N}_{ci} + {N}_{ce} + {N}_{fp} + {N}_{fn} )}^{2}}$$

Using this method of assessment persons skilled in the art of classification will be able to assess the impact of that each type of error. Having a number of categories or classification classes greater than two (that is, beyond a classification of “in” or “out” of one region) merely changes the algorithm for assessing the impact of the false positives and false negatives by changing the complexity of calculating the inclusions and exclusions. The calculation of the impact of false positives and false negatives is sometimes modified by multiplying each term by the corresponding risk associated with the type of error, thus resulting in a cost during geo-exploration for the type of error. Thus, measures other than probability-based calculations that are still based in part on the number and type of classification error can be used to evaluate the overall net classification result. For instance, evaluating the ratio of the sum of correct inclusions and exclusions to the sum of false positives and false negatives would be such a related measure. The difficulty in conventionally practiced classification is that evaluating the correctness of the inclusions and exclusions frequently has to be determined by estimation theory or by independent a posteriori observations.

Redundancy in denoting the categories can reduce the computation load. This occurs because some simplification in this equation for probability of true overall classification is available when the decision on the data can be formed from the union of a number of binary decisions (each classification decision boundary separates the data into two regions, with data points that are not in the included set automatically classified as being in the set of exclusion). Thus the decision boundary confining a given category can be defined by those points in the data that are excluded since they are included as members of the other categories. The import is that if inclusions and exclusions not need both be calculated for the geo-operator, considerable computational savings for this invention exist over the existing art.

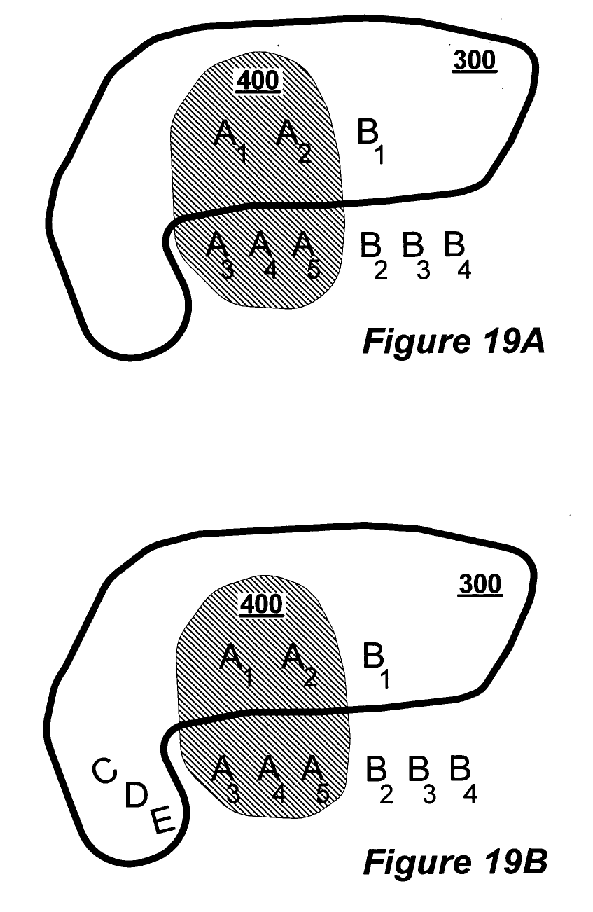

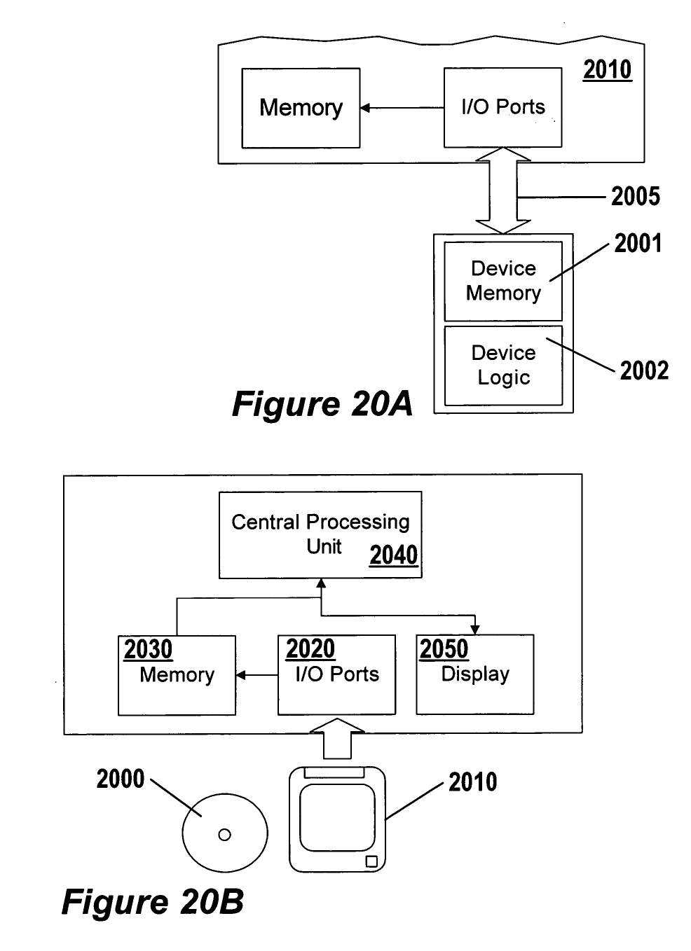

FIG. 19 shows a simple case that illustrates these concepts. FIG. 19A shows the case where the A objects and the B objects are classified with error using boundary 300. Here A is an object to be included and B represents an object that is not part of the desired classification boundary 300 which is meant to signify in FIG. 19A that B is to be excluded. Counting the number of A and B objects (which have subscripts as shown to allow counting) the number of correct inclusions is 2 (comprising A1 and A2), the number of correct exclusions is 4 (comprising B2, B3, B4 and B5), while the false positives are 1 (specifically, B1) and the false negatives are 3 (comprising A3, A4, A5). The overall net probability of correct classification is thus 6 out of 10. (Note that these errors are due to the fact that the boundary 300 between objects A to be included and objects B to be excluded was drawn imperfectly (depending on some underlying error). It can also be seen that if the boundary were drawn as 400, that this boundary as shown clearly separates the two groups A and B with no error. For the purposes of identification or detection of the presence of the A objects, the boundary also works by being used to exclude the B objects. FIG. 19B shows that the locus 400 can be defined by exclusion of a multiplicity of categories. In the specific case used for illustrative purposes shown in FIG. 20B the locus 400 can be defined as the locus within objects of “not A” are to be excluded (B, C, D, E for example as shown in FIG. 19B). In FIG. 19B the locus or boundary 400 can be seen to be the locus that avoids all such objects B through E, which are not objects of type A. Thus as shown by the simple example of this FIG. 19, for the purposes of classification, if the boundary can be drawn with minimum error the correct classification of an object can be effected by either using inclusion of a the single category (FIG. 19A) or exclusion all other categories (FIG. 19B). Because such classification can be performed in a geo-operator, the ability to use the minimum number of points, either by inclusion or by exclusion, can provide an economy of computation time.

Implementation Techniques

The geo-operator can be implemented as a device in hardware or software or any combination of hardware and software. FIG. 20 shows two manifestations, one that is chiefly hardware and one that is chiefly software. FIG. 20A shows implementation as a hardware device. The device is composed of device memory (2001) and device logic (2002) interfaced to the host computer (2010) through a bi-directional bus (2005). The logic (which can be held in programmable-gate-arrays or programmable-logic-devices (“PLDs”), or types of programmable-read-only memory or proms or other digital or analog storage) would control the interface to the host computer through the bi-directional bus. The device logic portion of the device would send interrupts to the host computer and poll the host computer to make a copy of data in host memory, if needed. The host computer would send path coordinates or a register location for the path on which the geo-operator is to operate. The device logic would provide a hardwired computation of the algorithm using the data the device had accessed, and would send interrupts to display the results on the host computer display. It can be appreciated that nonlinear as well as linear input-output relationships (with the seismic or non-seismic data as the input and the geo-operator calculation as output) can be performed using such systems of control, by means of analog or digital methods or a combination of analog and digital methods. FIG. 20B shows implementation in a computer system. The programming for the method would be stored on media such as a ROM (2000) or disk media storage (2010), and are interfaced through standard ports for this purpose (2020). The memory (2030) of the computer system stores the program, the original seismic data, and intermediate and final computed results. The central processor unit (2040) controls all of the other blocks of the system, having been programmed by one or more software programs, one of which is the geo-operator program brought in from the media 2000 or 2010, from which it had been moved to memory (2030). The computer program causes a flag to be set when the computation is complete, at which point the central processing unit can cause the transfer of the results from the memory to the display (2050) for visualization. It should be noted that the implementation may be done with any degree of concentration in hardware or software that achieves the result of this invention.

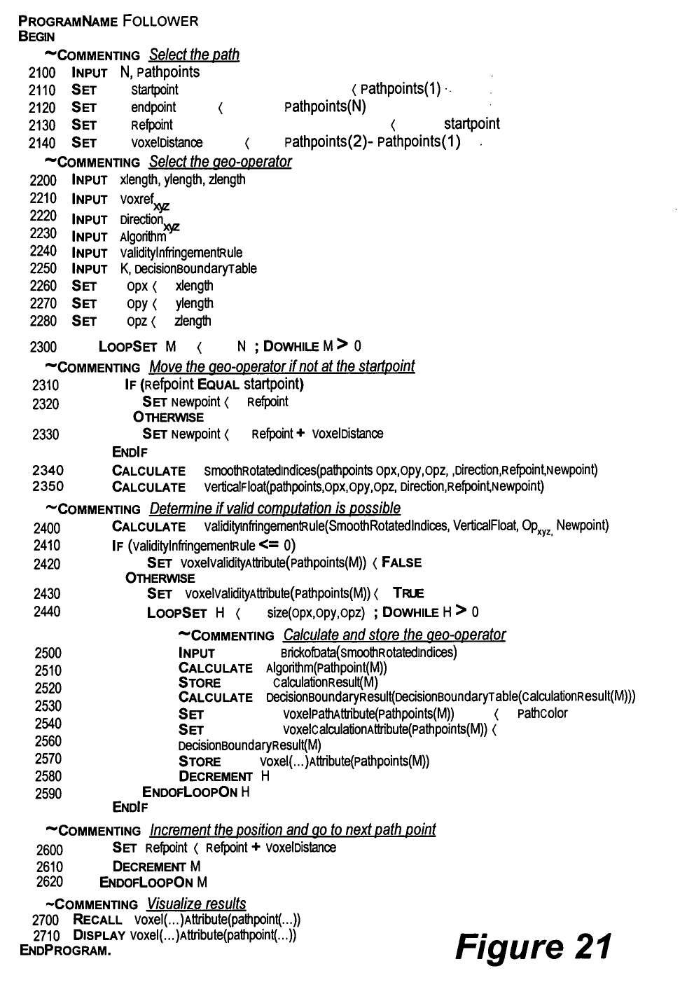

The geo-operator can be implemented as a set of computations. The methods of applying the actual geo-operator algorithms of multiple-input multiple-output is well known by computer practitioners skilled in the art of application programming. The implementation of the path tracking can be provided in pseudocode as shown in FIG. 21, allowing it to be translated into the syntax of any computer language suitable for Von-Neumann sequential, or parallel processing computers. Such a path-tracking procedure (called here a “Follower”) provides a vehicle to allow computations to proceed along geologic structure that are independent of the geo-operator calculation kernel, and allows alternative modularized geo-operator calculation kernels to be used or substituted. The coding shown is the essential coding needed, and a programmer might add additional coding without altering the purpose or function of the invention. Lines 2000-2100 allow the interpreter to input the path. This customarily follows a horizon, although an arbitrary path can be input for reconnaissance purposes. Lines 2200-2208 allow the input of the geo-operator size, the location of the voxel reference, the direction referencing technique, the calculation algorithm, and the granularity of the decision boundary table and rules for decisions. The operator is moved along the path in the loop on the variable M given in the program, between lines 2400 and 3400. After the procedure is started, the centroid of the operator is moved to the next position on the path. The operator will need a complete set of dataset voxels to interrogate, and there must be a complete set available to make a valid computation. A check must be made at this point to see if enough voxels will be available, and to check to make sure that the edge of the data set will not be impinged. (Other validity checks can be made at this time, as well, and this may vary by individual geoscientist preference.) The easiest method to perform the alignment of the geo-operator is to perform a smooth rotation in plan view (normally the inline and crossline directions) of the projection of the path on map view, and then to adjust the heights of the voxels in the geo-operator relative to the centroid voxel of the geo-operator to allow the geo-operator to conform to the path in the vertical direction. Other techniques involving translations and rotations (including quaternion methods) may be substituted without altering the purpose, result or function of the invention. The smooth rotation and vertical alignment of the geo-operator is performed in the program in lines 2600 and 2700. The calculation of the validity of the calculation is made in line 2800. If the calculation will be valid, it is allowed to proceed in the lines following 2830. Lines 2840-3000 calculate the algorithm for each voxel in the geo-operator, and store the calculation result, and the decision position relative to the decision boundary table, as well as coloring the path to illuminate it for the operator. Note that this method of visualization would allow the decision boundary matrix with its K thresholds to be altered and redisplayed without significant recalculation, thus assisting decision mining. In lines 3500 and 3600 the stored data is allowed to refresh the display. (As a matter of preference, there can be a real-time display between lines 2980 and 3000. Also as a matter of preference, an iterative calculation loop can be placed around lines 2840-3000 if it is desired to hunt mathematically to optimize solutions, without changing the intent or purpose of this invention.)

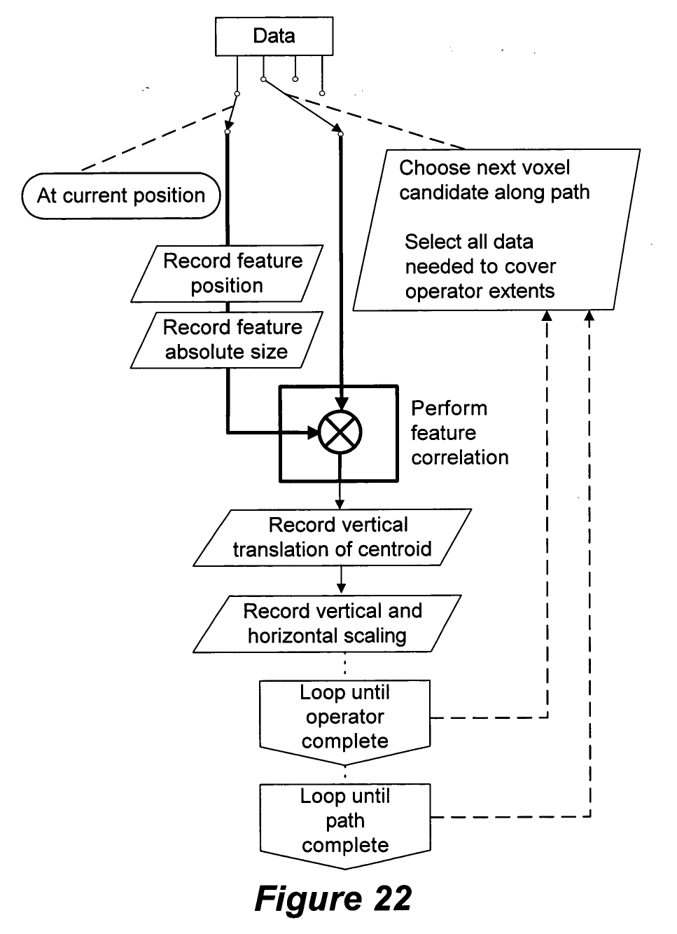

In an alternative embodiment, the geo-operator is used to locally flatten the data, as depicted in FIGS. 4A and 4B. For the one or two dimensional case shown in FIG. 4A, the cardinality transformation (43) can be found measuring the translation the feature between positions for instance 40, 41 and 42, and measuring the scaling required to register contiguity shown in FIG. 4A. Note that what we are considering here is the contiguity represented by the feature denoted by 40. (At the position 42 there is a dropout of this contiguity.) This book keeping of the translation and scaling can be done using the process depicted in FIG. 22. Note that the process in FIG. 22 includes a lateral dimension to include the changes in strata in 3D. Considering FIG. 4A, finding the cardinality transformation in 3D involves translation (following the vertical centroid in positions 40, 41 and 42), scaling (following the absolute vertical extent, right to left in FIG. 4A) and scaling (following the absolute vertical extent in and out of the page of FIG. 4A). (This description of the movement technique is Cartesian without loss of generality, since any movement coordinates can be used.) The feature correlation block in FIG. 22 is the set of techniques necessary to register the position centroid and scaled extent of the feature during its movement along the path. The techniques include, but are not limited to, Boolean ORing or ANDing, and ordinary linear and nonlinear mathematics. It will be recognized by those skilled in the arts that such techniques are customary and well known in the stretching and migration of well data when attempting to tie seismic data. It is well understood that a purely horizontal feature that is expressed as “110001100011” may be chosen to be viewed as equivalent to “11110000001110000001111” under scaling, and that the feature correlator would provide a scaling factor of times two for such a case. (Such scaling is under the control of the geoscientist, in the case where he would view the presence of scaling to arise from a physical factor which he wished to detect.) This may be viewed as an expansion of the simple feature definitions 100 and 200 of FIG. 2 that is of utility in geoscience. The use of genetic sequencing (such as mentioned by Wentland) and evolutionary computing readily provides the techniques used for the feature correlator. An important point of the method is to compare a feature at one path position of the geo-operator to the next path position, using a fitness function, and constructing genetic operators used to scale the geo-operator to account for the feature morphing that has occurred at this next path position. The translation and scaling that occurs during the movement is recorded, and the catalog of all these records show how the feature is evolved by the changes in the strata manifold as the cardinality transformation for the dataset. At the position 42 in FIG. 4A, of course there will be data dropout, which is a categorization that the operation of the genetic operator and the fitness function must output. Note also that in this alternative embodiment, that the set of candidate voxels selected for comparison with the reference path position may be larger than that of the geo-operator extents, since the possibility of positive (expansive) scale factors has to be admitted, along with the effect of translation of the center of the geo-operator. In this way, the geo-operator can actually be moved along Cartesian coordinates (inline, crossline and depth, or any other orthogonal coordinates) to find the cardinality transformation.

### EXAMPLE

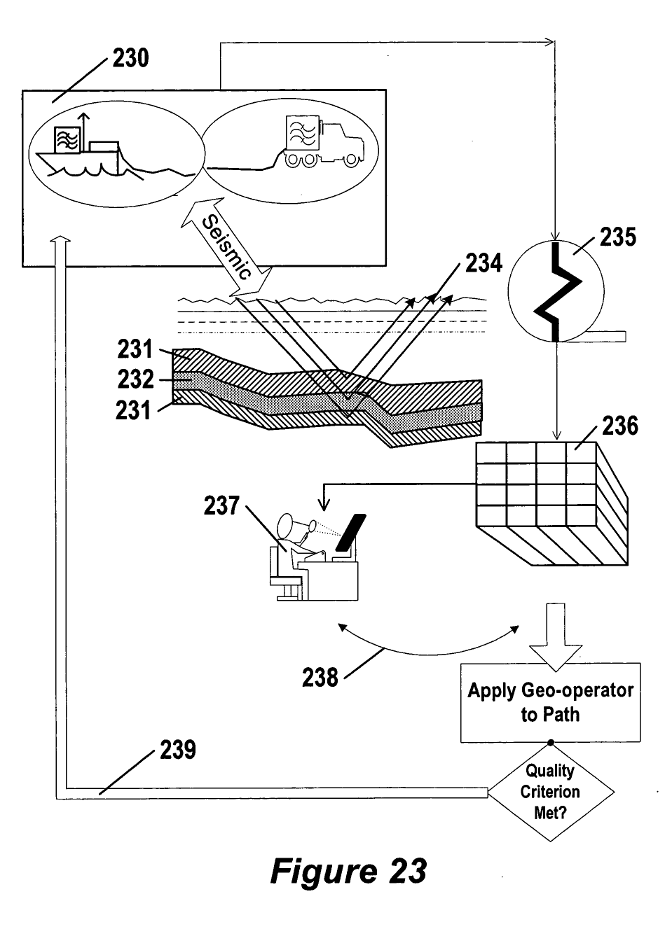

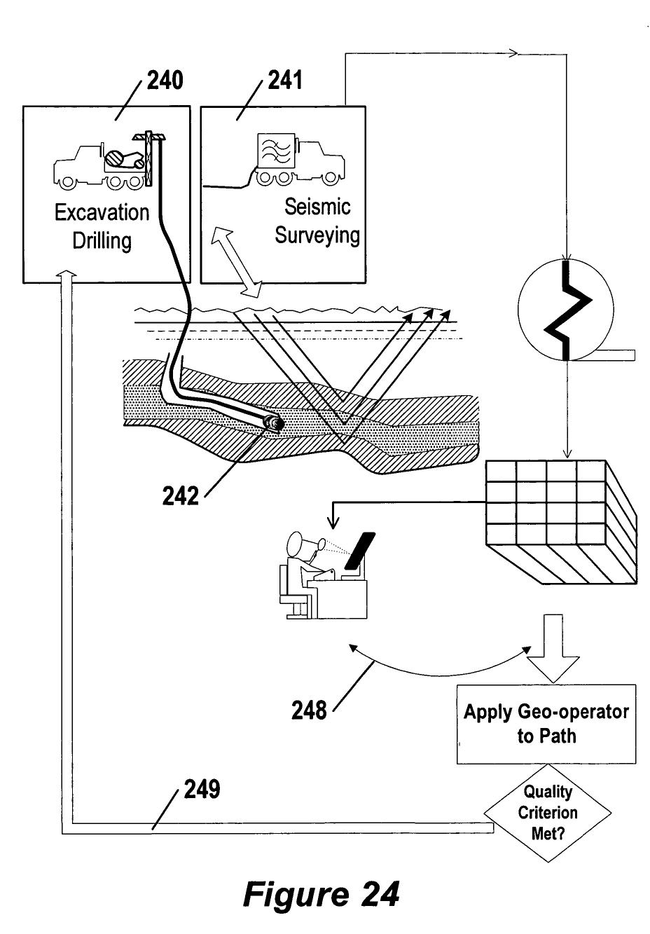

Having observed the details of some of the geo-operator technique to discover natural resources, attention may now be given to the practical purpose to which the geo-operator can be applied during real-time exploration (as shown in FIG. 23) or for real-time control of excavation (as shown in FIG. 24).

For the purpose of illustrating practical exploration of a natural resource, the arrangement of FIG. 23A shows seismic exploration through the use of interpretable 3D surveys, using either land or sea based acoustic sources and receivers (230). In three-dimensional seismic exploration, point sets of seismic survey data are used to determine the subsurface reflecting interfaces (231, 232, 233) and the average seismic velocity along the path (234) to the reflecting interface. When properly processed (235), the cross patterns of energy emanating from the multiple sources and scattered into the receivers will reveal the strike, dip and velocity of the underlying reflection surfaces. The processing involves correcting each seismic trace for dip or azimuth dependence of the migration velocities and for the geometric spreading of the wavefront between the source and receiver locations. These corrections allow multiple traces to be stacked into cells corresponding with each receiver location. Such processing allows the use of computer techniques to provide a clearly resolved, three-dimensional display of a volume of the subsurface earth. The four-dimensional vector data (vector values at voxels with inline, crossline and depth matrix coordinates) can be considered to be an array of voxel matrix values (236) of the data. Visualization techniques used to render such a display for an interpreter (237) are well known to those skilled in the art. A common (and for this invention may be considered standard) technique is to display the seismic or seismic derived amplitude at its corresponding inline, crossline and depth voxel cell position with a color or false-color attribute. This allows a skilled interpreter to visualize the strike and dip of reflections that denote stratigraphic and structural surfaces.

The use of feedback control of excavation is shown in FIG. 24. The seismic data, in this case from a land survey crew (240), is processed, stored and analyzed similar to the methods of FIG. 23. However, in the case of feedback control co-located with the tool (242), sensor data is used to control the operation of excavation or boring tools. The purpose of such control generally is to prevent the drilling tool from migrating into non-pay regions and lowering the productivity of the recovery of the natural resource. In some variations of the feedback control of excavation, energy sources other than seismic are used for the information, and the radiator of the energy may be on the drilling tool.

Without loss of generality, consider the sea-based exploration case shown in FIG. 23. As signal acquisition and computer processing hardware and software become more efficient, the real-time control of survey information to provide detailed information about subsurface structures is possible. This has the novel advantage of being able to produce a more detailed survey based on a timelier interpretation using pattern recognition made available by using geo-operators applied to paths discerned from an initial scan. To accomplish this, initial interpreter analyses (either from human or machine interpretation) resulting from applying the geo-operator in reconnaissance mode provide a first-tier screening of the data to mine for potential geological play concepts. The geoscientist (237) interacts to select alternative paths or calculation algorithms that will cause the geo-operator to sharpen the data (238) Note that the degree of computer automation is selectable and the ultimate goal may be to reduce the workload on the geoscientist by automating step 238. The output of the geo-operator analysis (239) is used to re-vector the ships conducting the survey to ensure data quality. An additional advantage occurs using ships that have real-time positioning thrusters, since the seismic sounding of adjacent lines can be made much more coherent in phase, thus improving data quality. A comparison can be made of the geo-operator output on successive scans to determine if the errors have been resolved. As shown in FIG. 24 for use in improving excavation quality, the feedback principle relies on pattern recognition available from employing geo-operator analysis of subsurface resource veins to maintain drilling quality (249). The geo-operator output before and during drilling is compared to provide real-time correction of the tool parameters in a measure while drilling “MWD” mode.

The reader will see that the geo-operator technique of analyzing natural resources shown by the invention provides a technique that efficiently allows classification boundaries to be visualized and pattern recognition to be practiced to enable locating natural resources and to control the recovery of natural resources. While the above description contains many specificities, these should not be construed as limitations on the scope of the invention, but rather as an exemplification of one preferred embodiment thereof. Many other variations are possible, depending on the type of calculation used within the geo-operator, being of deterministic, statistical or probabilistic, linear or nonlinear techniques and may include the mapping of other sensor data into the geo-operator calculation. Thus, while the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An apparatus for calculating and displaying 3D seismic classification features comprising:
designation means for designating a path in a 3D volume;
reference means for selecting a reference starting and ending position;
a geo-operator calculated from the voxel data of said 3D volume, said geo-operator capable of having variable crossline, inline and vertical extent and having
an orientation direction such that it can be maintained tangent to said path, as it traverses from the start point to the endpoint of said path;
association means for associating horizontal (2D), vertical (2D) and arbitrary (3D) feature vectors with the geo-operator output; and
determination means for determining where the geo-operator has sufficient data for the calculation to form a valid output;
wherein the output of the geo-operator indicates a measure to which alternative prototypical feature tensors may be present along the path.

2. A process for a device for calculating and displaying 3D seismic classification features relying on a means of designating a path in a 3D volume comprising:
employing a geo-operator calculated from the voxel data of said 3D volume, said geo-operator capable of having variable crossline, inline and vertical extent and having a an orientation direction such that it can be maintained tangent to said path, as it traverses from the start point to the endpoint of said path;
using an association means of associating horizontal (2D), vertical (2D) and arbitrary (3D) feature vectors with the output of said geo-operator; and
with a determination means of determining where the geo-operator has sufficient data for the calculation to form a valid output;
wherein the output of the geo-operator indicates a measure to which alternative prototypical feature tensors may be present along the path.

3. An apparatus for calculating and displaying 3D seismic classification features comprising:
a path in a 3D volume, the path having a reference start position and a reference end position; and
a geo-operator capable of generating an output, the geo-operator comprising:
an evaluation component that determines where the geo-operator has sufficient data to generate the output;
wherein the output of the geo-operator indicates a measure to which alternative prototypical feature tensors may be present along the path.

4. The apparatus of claim 3, wherein the feature vector is horizontal.

5. The apparatus of claim 3, wherein the feature vector is vertical.

6. The apparatus of claim 3, wherein the feature vector is arbitrary.

7. The apparatus of claim 3, wherein the feature vector is two dimensional.

8. The apparatus of claim 3, wherein the feature vector is three dimensional.

9. The apparatus of claim 3, wherein the geo-operator is calculated from voxel data of the 3D volume.

10. The apparatus of claim 3, wherein the geo-operator has a variable crossline.

11. The apparatus of claim 3, wherein the geo-operator has a variable inline.

12. The apparatus of claim 3, wherein the geo-operator has a vertical extent.

13. The apparatus of claim 3, wherein the geo-operator further comprises:
an orientation direction constructed and arranged to be maintained tangent to the path from the start position to the end position.

14. The apparatus of claim 3, wherein the geo-operator further comprises:
one or more feature vectors that are associated with the output of the geo-operator.

15. A method for calculating and displaying 3D seismic classification features along a path having a startpoint and an endpoint, comprising:
employing a geo-operator that is calculated from voxel data of the 3D volume, the geo-operator capable of having variable crossline, inline and vertical extent and having an orientation direction that is maintained tangent to the path as the path is traversed from the startpoint to the endpoint, the geo-operator generating output along the path;
determining where the geo-operator has sufficient data to generate the output;
generating output with the geo-operator; and
associating horizontal, vertical and arbitrary feature vectors with the output of the geo-operator;
wherein the output of the geo-operator indicates a measure to which alternative prototypical feature tensors may be present along the path.

16. An apparatus for locating an underground structure comprising:
a source of sensor information; 3D data covering at least a portion of the structure;
a geo-operator on a path within the 3D data, the geo-operator constructed and arranged to conform to the direction and the orientation of a tangent to the path, the geo-operator further constructed and arranged to alter dynamically the size of the geo-operator depending on the conditions of a point along the path.

17. The method of claim 16, wherein the geo-operator further constructed and arranged to correlate with physical phenomena in order to describe a natural resource.

18. The method of claim 16, wherein the geo-operator further constructed and arranged to correlate with physical phenomena in order to align with a boundary for a natural resource.

19. The method of claim 16, wherein the geo-operator further constructed and arranged to correlate with physical phenomena in order to provide a mathematically discernible boundary for a natural resource.

20. The method of claim 16 wherein the sensor provides information of the group consisting of electromagnetic, gravity and particulate.

21. The method of claim 16, wherein the sensor information is seismic.

22. The method of claim 20, wherein the sensor provides information of the group consisting of electromagnetic, gravity and particulate.

23. The method of claim 16 further comprising:
drilling a well capable of recovering at least a portion of the natural resource.

24. A method of generating a map displaying a set of geologic characteristics specific to a path having a plurality of points, comprising:
assigning a calculation result based on the combined horizontal and vertical features centered at each point along the path;
assigning a visual indication of the result to each point of the path; and
assigning a validity measure to each of the points based on the availability of data in order to makes changes in the result discernible by an interpreter.

25. A method of developing a cardinality transformation comprising:
designating a path in a 3D volume;
determining, with a fitness function, the status of a selected reference classification feature in a form at an adjacent path position;
determining the translation movement of the position of a centroid of the classification feature in the transition to the adjacent path position;
determining the morphing scaling of one or more extents of the feature in the transition to the adjacent path position; and
recording the translation movement and the morphing scalings to form a catalog of the changes in the strata manifold.

26. The method of claim 25, wherein the selected reference classification feature is one dimensional.

27. The method of claim 25, wherein the selected reference classification feature is two dimensional.

28. The method of claim 25, wherein the selected reference classification feature is three dimensional.

29. The method of claim 25, wherein the status is present.

30. The method of claim 25, wherein the status is absent.

31. The method of claim 25, wherein after the step of designating, then selecting a starting position and an ending position along the path.

32. The method of claim 25, wherein the form is morphed.

33. The method of claim 25, wherein the form is unmorphed.

34. A method of data fusion comprising:
providing a path having a plurality of points;
performing a first calculation with a geo-operator using a first type of data in a calculation algorithm;
performing a second calculation using a second type of data to form an output of the geo-operator; and
switching the order of the first calculation and the second calculation at each point along the path;
wherein the output of the geo-operator provides an indication of both sensor data for determining the classification nature of each point on the path.

35. A method of data fusion comprising:
providing a path having a plurality of points;
performing a first calculation with a geo-operator using a first type of data in a calculation algorithm;
performing a second calculation using a second type of data to form an output of the geo-operator; and
admixing the first calculation and the second calculation at each point along the path;
wherein the output of the geo-operator provides an indication of both sensor data for determining the classification nature of each point on the path.

36. The method of 35, wherein the admixing is linear.

37. The method of claim 35, wherein the admixing is nonlinear.

38. The method of 35, wherein the admixing is mathematical.

39. A method of data fusion comprising:
providing a path having a plurality of points;
performing a first calculation with a geo-operator using a first type of data in a calculation algorithm;
performing a second calculation using a second type of data to form an output of the geo-operator; and
blending the first calculation and the second calculation at each point along the path;
wherein the output of the geo-operator provides an indication of both sensor data for determining the classification nature of each point on the path.

40. The method of 39, wherein the blending is visual.

41. The method of 39, wherein the blending is optical.

42. A program storage device including a plurality of instructions, the instructions adapted to be executed by a processor of a computer, the instructions, when executed by the processor, conducting a process which generates a map that displays a set of geologic characteristics corresponding to the combined horizontal and vertical features based on data at one or more points along a path comprising:
assigning a calculation based on the combined horizontal and vertical features centered at each point along the path to form a result for that point;
assigning a visual indication of the calculation result for each point along the path; and
assigning a validity measure to each point along the path, the validity measure being based upon the availability of data for the calculation so that changes in the results are discernible by an interpreter.

43. A computer program product for generating a map that displays a set of geologic characteristics corresponding to the combined horizontal and vertical features based on data at one or more points along a path, the computer program product comprising:
A computer usable medium having a computer readable program code embodied in the medium for performing a calculation using as input the combined horizontal and vertical features centered at each point along the path, the computer readable program code including:
a first computer readable program code adapted for causing the computer to assign a computed result to each point along the path;
a second computer readable program code assigned to calculate a validity mask for the calculation along the path; and
a third computer readable program code assigned to provide the visualization of the path, the computed result and the validity mask.

44. An apparatus for mining underground structures comprising:
one or more sources;
one or more receivers;
a tool to mine in a designated place;
a feedback system relying on the data obtained from the sources and the receivers to maintain the tool in the designated place most productively, the feedback system controlling the tool to recover a portion of a natural resource using information from a geo-operator.

45. The method of claim 44, further comprising:
controlling the sources and receivers in real-time to modify the characteristics of the processing of the sources or receivers based upon the geo-operator to improve the quality of the natural resource.

46. The method of claim 44, wherein the source is seismic.

47. The method of claim 44, wherein the source is electromagnetic.

48. The method of claim 44, wherein the source is electric.

49. The method of claim 44, wherein the source is magnetic.

50. The method of claim 44, wherein the source is gravity.

51. The method of claim 44, wherein the source is particulate.

52. The method of claim 44, wherein the receiver is seismic.

53. The method of claim 44, wherein the receiver is electromagnetic.

54. The method of claim 44, wherein the receiver is electric.

55. The method of claim 44, wherein the receiver is magnetic.

56. The method of claim 44, wherein the receiver is gravity.

57. The method of claim 44, wherein the receiver is particulate.

58. The method of claim 44, wherein the tool is a cutting tool.

59. The method of claim 44, wherein the tool is an excavation tool.

60. The method of claim 44, wherein the tool is a drilling tool.

61. The method of claim 44, wherein the designated place is a channel.

62. The method of claim 44, wherein the designated place is a bed.

63. The method of claim 44, wherein the information from the geo-operator is based upon the results of a geo-operator calculation.

64. The method of claim 44, wherein the information of the geo-operator is control information.

65. The method of claim 44, wherein the information of the geo-operator is regulator information.

66. The method of claim 45, wherein the characteristic is directionality.

67. The method of claim 45, wherein the characteristic is waveform.
